(19) United States
(12) Patent Application Publication
(10) Pub. No.: US 2025/0128261 A1
(43) Pub. Date: Apr. 24, 2025

(54) ADJUSTABLE DROPLETS DISTRIBUTION

(71) Applicant: SUZHOU SINGLERON BIOTECHNOLOGIES CO., LTD., Suzhou (CN)

(72) Inventors: Yunyan QIU, Suzhou (CN); Yanhong MA, Suzhou (CN)

(21) Appl. No.: 18/730,289

(22) PCT Filed: Jan. 19, 2023
(86) PCT No.: PCT/CN2023/073117

§ 371 Date: Jul. 18, 2024

(30) Foreign Application Priority Data
Jan. 20, 2022 (WO) PCT/CN2022/072841

(51) Int. Cl. B01L 3/00

(52) U.S. Cl. CPC B01L 3/502784; B01L 2200/0673; B01L 2300/0816; B01L 2300/0867; B01L 2300/0883; B01L 2400/043

(57) ABSTRACT

The present disclosure provides methods, reagents, compositions, and systems for particle distribution and cell analysis. Cells and adjustable droplets each with a particle encapsulated therein can be distributed into microwells of a microwell array. The encapsulated particle can be released in to the microwell. The present method and system can be used for high-throughput single cell sample preparation, and can avoid current limitations on microwell sizes and expand the application of single cell analysis.

### BACKGROUND

### Field

The present disclosure relates generally to the field of molecular biology, specifically barcoding and cell analysis.

### Description of the Related Art

Single cell sequencing can provide genetic information of a single cell. One approach is to separate a single cell and independently construct a sequencing library for sequencing. This approach, however, suffers from low throughput, high cost, and high demand for time, manpower, material resources, and automation equipment, and, as a result, cannot achieve high-throughput cell analysis. Barcoding technologies can be used to identify single cells (e.g., by labeling a cell with a unique barcode sequence). Sequences having a same barcode sequence can be identified as originating from the same cell, thus allowing for analysis of hundreds to thousands of cells in one library construction process. Microwell arrays can be used for preparing single cell samples based on the Poisson distribution of the cells into the microwells. The cells are placed into the microwells by gravity and can be separated by the microwell. Beads attached with barcode molecules are then be placed in the microwells. By this approach, each microwell can contain one or no cell, and each microwell can contain a bead. Single cell samples can be prepared after cell lysis and barcoding. There remains a need for more efficient and cost-effective single cell sample preparation methods.

### SUMMARY

Provided herein include methods, reagents, compositions, and systems for particle and cell distribution, which can be used for high-throughput single cell sample preparation.

Disclosed herein include methods of particle distribution. In some embodiments, the method comprises: providing a plurality of droplets each with a particle encapsulated therein; distributing the plurality of droplets into a plurality of microwells of a microwell array, thereby at least 25% of the plurality of microwells each comprises a single droplet of the plurality of droplets, wherein each of plurality of microwells is capable of fitting at least two particles, and wherein each of the plurality of microwells is capable of fitting at most one droplet; and releasing the particle in each of the single droplets into the microwell comprising the single droplet, thereby the microwell comprises a single particle.

Disclosed herein include methods of particle and cell distribution. In some embodiments, the method comprises: distributing a plurality of droplets each with a particle encapsulated therein into a plurality of microwells of a microwell array, thereby at least 25% of the plurality of microwells each comprises a single droplet of the plurality of droplets, wherein each of plurality of microwells is capable of fitting at least two particles, and wherein each of the plurality of microwells is capable of fitting at most one droplet; releasing the particle in each of the single droplets into the microwell comprising the single droplet, thereby the microwell comprises a single particle; and distributing a plurality of cells into the plurality of microwells of the microwell array, thereby at least 25% of the plurality of microwells each comprises a single cell of the plurality of cells.

In some embodiments, the method of particle distribution comprises: distributing a plurality of droplets each with a first particle encapsulated therein into a plurality of microwells of a microwell array, thereby at least 25% of the plurality of microwells each comprises a single droplet of the plurality of droplets, wherein each of plurality of microwells is capable of fitting at least two first particles, and wherein each of the plurality of microwells is capable of fitting at most one droplet; releasing the first particle in each of the single droplets into the microwell comprising the single droplet, thereby the microwell comprises a single first particle; and distributing a plurality of second particles into the plurality of microwells of the microwell array, thereby at least 25% of the plurality of microwells each comprises a single second particle of the plurality of second particles.

In some embodiments, after distributing the plurality of droplets into the plurality of microwells, each of the plurality of microwells comprises at most one droplet. In some embodiments, after releasing the particle in each of the single droplets into the microwell comprising the single droplet, each of the plurality of microwells comprises at most one particle. In some embodiments, after distributing the plurality of droplet into the plurality of microwells, at least 50% of the plurality of microwells each comprises a single droplet of the plurality of droplets. In some embodiments, after distributing the plurality of cells into the plurality of microwells, at least 50% of the plurality of microwells each comprises a single cell of the plurality of cells. In some embodiments, after distributing the plurality of droplets into the plurality of microwells and distributing the plurality of cells into the plurality of microwells, at least 50% of the plurality of microwells each comprises a single droplet of the plurality of droplets and a single cell of the plurality of cells.

In some embodiments, distributing the plurality of droplets into the plurality of microwells occurs before distributing the plurality of cells into the plurality of microwells, and/or releasing the particle in each of the single droplets into the microwell comprising the single droplet occurs before distributing the plurality of cells into the plurality of microwells. In some embodiments, distributing the plurality of droplets into the plurality of microwells occurs after distributing the plurality of cells into the plurality of microwells, and/or releasing the particle in each of the single droplets into the microwell comprising the single droplet occurs after distributing the plurality of cells into the plurality of microwells. In some embodiments, distributing the plurality of droplets into the plurality of microwells and distributing the plurality of cells into the plurality of microwells occur simultaneously.

In some embodiments, a size of the droplet is at least 2 times a corresponding size of the particle.

Disclosed herein include methods of cell analysis. In some embodiments, the method of cell analysis comprises: providing a plurality of droplets each with a particle encapsulated therein; partitioning the plurality of droplets into a plurality of microwells of a microwell array, thereby at least 25% of the plurality of microwells each comprises a single droplet of the plurality of droplets; releasing the particle in each of the single droplet into the microwell comprising the single droplet; partitioning a cell into a microwell of the microwells each with a particle released thereinto; and analyzing a plurality of target nucleic acids associated with the cell using the particle. In some embodiments, the method of cell analysis comprises: partitioning a plurality of cells into microwells of a plurality of microwells of a microwell array; partitioning a plurality of droplets into microwells of the plurality of microwells of the microwell array, each of the droplets comprising a particle encapsulated therein, thereby at least a portion of the plurality of microwells each comprises a single droplet of the plurality of droplets; releasing the particle in each of the single droplets into the microwell comprising the single droplet and the cell; and analyzing a plurality of target nucleic acids associated with the cell using the particle. In some embodiments, the plurality of cells are partitioned before the plurality of droplets are partitioned. In some embodiments, the plurality of cells are partitioned after the plurality of droplets are partitioned.

In some embodiments, the method of cell analysis comprises: co-partitioning (i) a plurality of droplets each with a particle encapsulated therein and (ii) a plurality of cells into a plurality of microwells of a microwell array, thereby at least 25% of the plurality of microwells of the microwell array each comprises a single droplet of the plurality of droplets and a single cell of the plurality of cells; releasing the particle in each of the single droplets into the microwell comprising the single droplet; and analyzing a plurality of target nucleic acids associated with a cell using a released particle in a microwell comprising the cell and the released particle.

In some embodiments, after partitioning the plurality of droplets, or after co-partitioning (i) the plurality of droplets and (ii) the plurality of cells, at least 50% of the plurality of microwells each comprises a single droplet of the plurality of droplets. In some embodiments, after releasing the particle in each of the single droplets into the microwell comprising the single droplet, at least 50% of the plurality of microwells each comprises a single particle released thereinto. In some embodiments, after partitioning the plurality of cells, or after co-partitioning (i) the plurality of droplets and (ii) the plurality of cells, at least 50% of the plurality of microwells each comprises a single cell of the plurality of cells.

In some embodiments, after partitioning the plurality of droplets and partitioning the plurality of cells, or after co-partitioning (i) the plurality of droplets and (ii) the plurality of cells, at least 50% of the plurality of microwells each comprises a single droplet of the plurality of droplets and a single cell of the plurality of cells. In some embodiments, after releasing the particle and after partitioning the plurality of cells, or after co-partitioning (i) the plurality of droplets and (ii) the plurality of cells, at least 50% of the plurality of microwells each comprises a single particle released thereinto and a single cell of the plurality of cells.

In some embodiments, the method of cell analysis further comprises, prior to analyzing the plurality of target nucleic acids: lysing the cell, thereby releasing the plurality of target nucleic acids from the cell.

In some embodiments, each of the plurality of microwells comprises at most one droplet of the plurality of droplets, and/or each of the plurality of microwells comprises at most one particle.

In some embodiments, each of plurality of microwells is capable of fitting at least two particles. In some embodiments, each of the plurality of microwells is capable of fitting at most one droplet. In some embodiments, a size of the droplet is at least 2 times a corresponding size of the particle. In some embodiments, a size of the cell is bigger than a corresponding size of the particle. In some embodiments, a size of the cell is smaller than a corresponding size of the particle.

In some embodiments, a size of the droplet is 5 μm to 200 μm, and/or a volume of the droplet is about 100 μm³ to 100,000 μm³.

In some embodiments, a volume of a microwell of the plurality of microwells is about 100 μm³ to 100,000 μm³. In some embodiments, a width of a microwell of the plurality of microwells is 10 μm to 500 μm, a length of a microwell of the plurality of microwells is 10 μm to 500 μm, or a depth of a microwell of the plurality of microwells is 10 μm to 500 μm. In some embodiments, a microwell of the plurality of microwells has a circular, elliptical, square, rectangular, triangular, or hexagonal shape. In some embodiments, a size of the microwell is less than 2 times a corresponding size of the droplet. For example, the width of the microwell can be less than 2 times the width of the droplet, the length of the microwell can be less than 2 times the length of the droplet, or the depth of the microwell is less than 2 times the height of the droplet.

In some embodiments, a size of the particle is about 5 μm to about 100 μm, and/or a volume of the particle is about 100 μm³ to 100,000 μm³.

In some embodiments, a volume of the cell is at least 2,000 μm³, and/or wherein a diameter of the cell is at least 50 μm. In some embodiments, the width of the microwell is less than 2 times the diameter of the cell, the length of the microwell is less than 2 times the diameter of the cell, or the depth of the microwell is less than 2 times the diameter of the cell.

In some embodiments, the methods disclosed herein can comprise generating the plurality of droplets each with a particle encapsulated therein. For example, the methods can comprise generating the plurality of droplets each with a particle encapsulated therein and each with a predetermined size. The method can comprise generating the plurality of droplets each with a particle encapsulated therein and each with a size within a range of a predetermined size.

In some embodiments, generating the plurality of droplets each with an encapsulated particle comprises: introducing the particles in a first medium into a second medium to form the plurality of droplets each with an encapsulated particle. For example, introducing the particle in the first medium into the second medium can comprises: merging the first medium comprising the particles in a first channel with the second medium in a second channel.

In some embodiments, introducing the particles in the first medium into the second medium comprises introducing the particles in the first medium into the second medium to form a plurality of droplets with no particle encapsulated therein, and generating the plurality of droplets each with an encapsulated particle comprises: separating the plurality of droplets each with an encapsulated particle from the plurality of droplets with no particle encapsulated therein.

In some embodiments, the plurality of particles comprise a plurality of magnetic beads, and separating the plurality of droplets each with an encapsulated particle comprises isolating the plurality of droplets each with an encapsulated particle from the plurality of droplets with no particle encapsulated therein. For example, the separating can comprise capturing the plurality of droplets with encapsulated particles by magnetically attracting the magnetic beads encapsulated in the plurality of droplets.

In some embodiments, the predetermined size of the droplet is determined by a flow rate of the first medium relative to a flow rate of the second medium. For example, introducing the particle in the first medium into the second medium can comprise introducing the particles in the first medium at a first flow rate into the second medium at a second flow rate, thereby forming the plurality of droplets each with the predetermined size or each with a size within a range of a predetermined size.

In some embodiments, releasing the particle comprises contacting the single droplet with an encapsulated particle with a demulsifier. In some embodiments, the droplet is a water-in-oil droplet. In some embodiments, the droplet is an oil-in-water droplet. In some embodiments, the first medium is an aqueous medium and the second medium is a non-aqueous medium. In some embodiments, the first medium is a non-aqueous medium and the second medium is an aqueous medium. The non-aqueous medium, for example, can be an oil.

In some embodiments, the particle comprises a plurality of barcode molecules. The barcode molecules of the plurality of barcode molecules, for example, can comprise an identical particle barcode sequence and different molecular label sequences. In some embodiments, analyzing the plurality of target nucleic acids associated with the cell comprises: barcoding the plurality of target nucleic acids using the plurality of barcode molecules to generate a plurality of barcoded nucleic acids; and analyzing the plurality of barcoded nucleic acids, or products thereof. In some embodiments, barcode molecules of the plurality of barcode molecules further comprise a target binding sequence.

In some embodiments, barcoding the plurality of target nucleic acids comprises extending the plurality of barcode molecules using the plurality of target nucleic acids as templates to generate the plurality of barcoded nucleic acids comprising a plurality of single-stranded barcoded nucleic acids, optionally hybridized to the plurality of target nucleic acids. The method can further comprise introducing a plurality of template switching oligonucleotides into the microwell, wherein barcoding the plurality of target nucleic acids comprises extending the plurality of barcode molecules using the plurality of target nucleic acids and the plurality of template switching oligonucleotides as templates to generate the plurality of barcoded nucleic acids comprising a plurality of single-stranded barcoded nucleic acids.

In some embodiments, the method can comprise introducing a plurality of extension primers to the microwell, and barcoding the plurality of target nucleic acids comprises extending the plurality of extension primers using the plurality of target nucleic acids as templates and the plurality of barcode molecules as template switching oligonucleotides to generate the plurality of barcoded nucleic acids comprising a plurality of single-stranded barcoded nucleic acids.

In some embodiments, each of the plurality of single-stranded barcoded nucleic acids is hybridized to one of the plurality of target nucleic acids and one of the plurality of template switching oligonucleotides in the microwell.

The method can, for example, further comprises removing the plurality of target nucleic acids and the plurality of template switching oligonucleotides hybridized to the single-stranded barcoded nucleic acids, optionally wherein removing the plurality of target nucleic acids comprises denaturation, thermal denaturation, digesting, or hydrolyzing the plurality of target nucleic acids. In some embodiments, each of the plurality of single-stranded barcoded nucleic acid comprises a sequence of a barcode molecule of the plurality of barcode molecules, a sequence of a target nucleic acid of the plurality of target nucleic acids, a sequence of a template switching oligonucleotide of the plurality of template switching oligonucleotides, and/or a sequence of an extension primer of the plurality of extension primers. A sequence can be the original sequence or a complementary sequence of the original sequence, such as the sequence of the reverse complement of the original sequence.

The method can, for example, further comprising amplifying the plurality of barcoded nucleic acids to generate a plurality of double-stranded barcoded nucleic acids in the microwell using the single-stranded barcoded nucleic acids as templates.

In some embodiments, the plurality of target nucleic acids comprises poly-adenylated messenger ribonucleic acid (mRNA) and the extension primers comprise a poly(dT) sequence. In some embodiments, each of the plurality of barcode molecules comprises a primer sequence. The primer sequence can, for example, comprise a PCR primer sequence. Amplifying the plurality of barcoded nucleic acids can comprise, for example, amplifying the plurality of barcoded nucleic acids using the primer sequences in single-stranded barcoded nucleic acids of the plurality of single-stranded barcoded nucleic acids, or products thereof.

In some embodiments, the plurality of target nucleic acids comprises deoxyribonucleic acid (DNA). In some embodiments, the plurality of target nucleic acids comprises ribonucleic acid (RNA). In some embodiments, barcoding the plurality of target nucleic acids comprises a reverse transcription reaction, and wherein the plurality of barcoded nucleic acids comprises complementary deoxyribonucleic acid (cDNA).

Barcoding the plurality of target nucleic acids can, for example, comprise hybridizing the target binding sequence to a target nucleic acid of the plurality of target nucleic acids. The target binding sequence can, for example, comprises a poly(dT) sequence and/or a sequence capable of hybridizing to the target nucleic acid, such as a sequence comprising a target specific sequence. In some embodiments, the target binding sequence of the barcode molecule comprises a poly(dT) sequence, and barcoding the plurality of target nucleic acids comprises hybridizing the poly(dT) sequence of the target binding sequence to a poly(A) sequence of a target nucleic acid of the plurality of target nucleic acids.

In some embodiments, the molecular label sequences comprise unique molecule identifiers (UMIs). the molecular label sequences, for example, can be 2-40 nucleotides in length. The barcode molecules of the plurality of barcode molecules can, for example, comprise a primer sequence, such as a sequencing primer sequence. The sequencing primer sequence, for example, can be a Read 1 sequence, a Read 2 sequence, or a portion thereof. In some embodiments, a barcode molecule of the plurality of barcode molecules comprises a template switching oligonucleotide. The plurality of barcode molecules can be, for example, attached to, reversibly attached to, covalently attached to, or irreversibly attached to the particle.

In some embodiments, the particle is a bead. In some embodiments, the bead is a gel bead, for example a hydrogel bead. In some embodiments, the gel bead is degradable upon application of a stimulus, including but not limited to a thermal stimulus, a chemical stimulus, a biological stimulus, a photo-stimulus, or a combination thereof. In some embodiments, the bead is a solid bead and/or a magnetic bead. In some embodiments, the method comprises retaining the bead in the microwell by an external magnetic field during one or more steps of the method. In some embodiments, the bead comprises a paramagnetic material.

In some embodiments, analyzing the plurality of barcoded nucleic acids, or products thereof, comprises determining the sequences of the plurality of barcoded nucleic acids, or products thereof.

In some embodiments, the present method can comprise generating or providing a plurality of water-in-oil droplets. The droplet can comprise a magnetic bead encapsulated therein. The magnetic bead can comprise a plurality of barcode molecules. The droplets each comprising a magnetic bead encapsulated therein can be enriched by magnetic attraction. The enriched droplets can be distributed into a plurality of microwells of a microwell array. The size of the droplet can match, or be similar to, the size of the microwell, such that, after distributing the droplets into the plurality of microwells, each of the microwells of the microwell array can comprise at most a single droplet distributed therein. The encapsulated magnetic bead can be released by contacting the single droplet in the microwell with a demulsifier, thereby releasing the magnetic bead into the microwell. A plurality of cells can then be distributed into the plurality of microwells. After releasing the encapsulated magnetic bead and distributing the cells, each of the microwells of the microwell array can comprise at most a single magnetic bead and at most a single cell. At a given size of the magnetic beads or cells, the present method can utilize a water-in-oil system to control the size of water-in-oil droplets, thus eliminating the size limit of microwells on the microwell array. The present method can be used to prepare microwells each comprising a single cell and a single particle (e.g., bead comprising barcode molecules), which expands the applications of microwell arrays in single cell capture and analysis.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIG. 1 shows a representative workflow of a particle distribution process disclosed herein.

FIG. 2 shows a representative microfluidic device for generating droplets with encapsulated particles.

FIG. 3A shows a representative scheme of generating droplets with encapsulated particles by introducing the particles in an aqueous phase into an oil phase. The size of the droplets can be adjusted, for example, by controlling the flow rates of the aqueous phase and the oil phase. FIG. 3B shows a representative distribution of particles in microwells. The circled location shows a 30 μm particle (e.g., a magnetic bead) distributed into a 100 μm microwell. FIG. 3C shows a plurality of microwells and a plurality of particles distributed into the microwells. Each of the microwells is sized so that it is capable of fitting at least two particles.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

Provided include methods, reagents, compositions, and systems for particle and cell distribution, which can be used for high-throughput single cell sample preparation.

### Method of Particle and Cell Distribution

In the current methods for preparing single cell samples using microwell array, in order to prevent loading two or more particles (e.g., beads comprising barcode molecules) into one microwell, the size of the microwell needs to be smaller than the sum of the sizes (e.g., diameters) of two particles. Such design limits the capture of large size cells or cells with irregular size (e.g., cardiomyocytes or nerve cells) and utility for clinical samples. The present disclosure provides high-throughput single cell preparation methods, devices, and applications capable of overcoming this problem, and can be used for distributing particles of specific size into partitions (e.g., microwells on a microwell array). The presently disclosed methods, devices and systems can improve the low particle-loading efficiency of the current methods, for example the low efficiency caused by partition size limitation (e.g., microwells being too big or too small for certain cells) or undesired distribution (e.g., microwells comprising multiple cells or particles, or microcells comprising no cell or no particle).

Disclosed herein include methods of particle distribution. The method can comprise providing a plurality of droplets wherein each of the plurality of droplets or each of substantial portion (e.g., 20%, 30%, 40%, 50%, 60%, 65%, 70%, 75%, 80%, 85%, 90%, 95%, 96%, 97%, 98%, 99%, or more) of the plurality of droplets containing a particle (e.g., a magnetic particle) encapsulated therein. The method can comprise distributing the plurality of droplets into a plurality of microwells of a microwell array, thereby, for example, at least 25% of the plurality of microwells can each comprise a single droplet of the plurality of droplets. In some embodiments, each of plurality of microwells or each of substantial portion (e.g., 20%, 30%, 40%, 50%, 60%, 65%, 70%, 75%, 80%, 85%, 90%, 95%, 96%, 97%, 98%, 99%, or more) of the plurality of microwells is capable of accommodating at least two particles. Each of the plurality of microwells or each of substantial portion (e.g., 20%, 30%, 40%, 50%, 60%, 65%, 70%, 75%, 80%, 85%, 90%, 95%, 96%, 97%, 98%, 99%, or more) of the plurality of microwells can be capable of accommodating at most one droplet (e.g., a single droplet). The method can further comprise releasing the particle from the single droplet encapsulated therein into the microwell containing the single droplet, thereby resulting in the microwell comprising a single particle.

Also disclosed herein include methods of particle and cell distribution. The method comprises distributing a plurality of cells into the plurality of microwells of the microwell array, thereby, for example, at least 25% of the plurality of microwells each comprises a single cell of the plurality of cells. The method can further comprise distributing a plurality of droplets wherein each of the plurality of droplets or each of substantial portion (e.g., 20%, 30%, 40%, 50%, 60%, 65%, 70%, 75%, 80%, 85%, 90%, 95%, 96%, 97%, 98%, 99%, or more) of the plurality of droplets containing a particle (e.g., a magnetic particle) encapsulated therein into the plurality of microwells of the microwell array, thereby, for example, at least 25% of the plurality of microwells each comprises a single droplet of the plurality of droplets. In some embodiments, each of plurality of microwells or each of substantial portion (e.g., 20%, 30%, 40%, 50%, 60%, 65%, 70%, 75%, 80%, 85%, 90%, 95%, 96%, 97%, 98%, 99%, or more) of the plurality of microwells is capable of accommodating at least two particles. In some embodiments, each of the plurality of microwells or each of substantial portion (e.g., 20%, 30%, 40%, 50%, 60%, 65%, 70%, 75%, 80%, 85%, 90%, 95%, 96%, 97%, 98%, 99%, or more) of the plurality of microwells is capable of accommodating at most one droplet. In some embodiments, the method comprises releasing the particle in each of the single droplets into the microwell comprising the single droplet, thereby the microwell comprises a single particle and/or a single cell.

In some embodiments, the method of particle distribution comprises distributing a plurality of droplets wherein each of the plurality of droplets or each of substantial portion (e.g., 20%, 30%, 40%, 50%, 60%, 65%, 70%, 75%, 80%, 85%, 90%, 95%, 96%, 97%, 98%, 99%, or more) of the plurality of droplets containing a first particle (e.g., a magnetic particle) encapsulated therein into a plurality of microwells of a microwell array, thereby, for example, at least 25% of the plurality of microwells each comprises a single droplet of the plurality of droplets. In some embodiments, each of plurality of microwells or each of substantial portion (e.g., 20%, 30%, 40%, 50%, 60%, 65%, 70%, 75%, 80%, 85%, 90%, 95%, 96%, 97%, 98%, 99%, or more) of the plurality of microwells is capable of accommodating at least two first particles and/or at most one droplet. The method can comprise releasing the first particle in a single droplet encapsulated therein into the microwell comprising the single droplet, thereby resulting in the microwell comprising a single first particle. The method can further comprise distributing a plurality of second particles into the plurality of microwells of the microwell array, thereby, for example, at least 25% of the plurality of microwells each comprises a single second particle of the plurality of second particles.

After distributing the plurality of droplets into the plurality of microwells of the microwell array, the percentage of microwells of the microwell array each comprising a single droplet can vary, for example, the percentage can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, at least 25% of the plurality of microwells each comprises a single droplet of the plurality of droplets.

The percentage of microwells of the microwell array capable of accommodating/fitting at most one droplet can vary, for example, the percentage can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, each of plurality of microwells is capable of accommodating/fitting at most one droplet.

The percentage of microwells of the microwell array capable of accommodating/fitting at least two particles (e.g., two first particles or two second particles) can vary, for example, the percentage can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, each of plurality of microwells can be capable of accommodating/fitting at least two particles (e.g., two first particles or two second particles).

The percentage of microwells of the microwell array each comprising a single second particle can vary, for example be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, at least 25% of the plurality of microwells can each comprise a single second particle of the plurality of second particles.

In some embodiments, after distributing the plurality of droplets into the plurality of microwells, each of the plurality of microwells can comprise at most one droplet (e.g., a single particle or no particle). After releasing the particle in each of the single droplets into the microwell comprising the single droplet, each of the plurality of microwells can, for example, comprise at most one particle (e.g., a single particle or no particle). In some embodiments, after distributing the plurality of droplet into the plurality of microwells, at least 50% of the plurality of microwells can each comprise a single droplet of the plurality of droplets.

After distributing the plurality of cells into the plurality of microwells of the microwell array, the percentage of microwells of the microwell array each comprising a single cell can vary, for example, the percentage can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, at least 25% of the plurality of microwells can each comprise a single cell of the plurality of cells. In some embodiments, after distributing the plurality of cells into the plurality of microwells, at least 50% of the plurality of microwells can each comprise a single cell of the plurality of cells.

After distributing the plurality of droplets and the plurality of cells into the plurality of microwells of the microwell array, the percentage of microwells of the microwell array each comprising a single droplet and a single cell can vary, for example, the percentage can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, after distributing the plurality of droplets into the plurality of microwells and distributing the plurality of cells into the plurality of microwells, at least 50% of the plurality of microwells each comprises a single droplet of the plurality of droplets and a single cell of the plurality of cells.

After droplet and cell distribution, the percentage of the plurality of microwells comprising no droplet, no cell, or neither droplet nor cell can be different in different embodiments. For example, the percentage of the plurality of microwells comprising no droplet, no cell, or neither droplet nor cell can be, be about, be at least, be at least about, be at most, or be at most about, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, or a number or a range between any two of these values. In some embodiments, at most 50% of microwells of the plurality of microwells can comprise no droplet, no cell, or neither droplet nor cell.

After droplet and cell distribution, the percentage of the plurality of microwells comprising two or more droplets and/or two or more cells can be different in different embodiments. For example, the percentage of the plurality of microwells comprising two or more droplets and/or two or more cells can be, be about, be at least, be at least about, be at most, or be at most about, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, or a number or a range between any two of these values. In some embodiments, at most 10% of microwells of the plurality of microwells can comprise two or more droplets and/or two or more cells.

The order in which the droplets and cells are distributed into the microwells can vary. For example, distributing the plurality of droplets into the plurality of microwells can occur before distributing the plurality of cells into the plurality of microwells. In some embodiments, releasing the particle in each of the single droplets into the microwell comprising the single droplet occurs before distributing the plurality of cells into the plurality of microwells. In some embodiments, distributing the plurality of droplets into the plurality of microwells occurs after distributing the plurality of cells into the plurality of microwells. In some embodiments, releasing the particle in each of the single droplets into the microwell comprising the single droplet occurs after distributing the plurality of cells into the plurality of microwells. In some embodiments, distributing the plurality of droplets into the plurality of microwells and distributing the plurality of cells into the plurality of microwells occur simultaneously. In some embodiments, releasing the particle in each of the single droplets into the microwell comprising the single droplet and distributing the plurality of cells into the plurality of microwells occur at the same time.

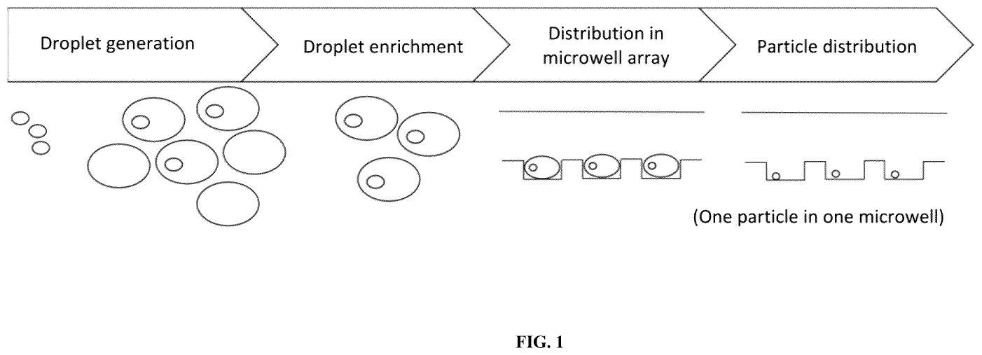

In some embodiments, as illustrated in FIG. 1, the present disclosure provides a method of high-throughput single cell sample preparation, which can comprise one or more steps of: (1) providing a plurality of droplets (e.g., water-in-oil droplets) of a specific size, each with a magnetic bead encapsulated therein; (2) optionally enriching the droplets with encapsulated magnetic bead in the plurality of droplets, for example by removing or reducing the numbers of droplets that do not comprise encapsulated magnetic bead in the plurality of droplets; (3) distributing the plurality of droplets (e.g., the plurality of droplets enriched with the droplets each comprising a magnetic bead encapsulated therein) into a plurality of microwells of a microwell array, such that each microwell of the microwell array contains at most a single droplet (e.g., no droplet, or a single droplet); (4) releasing the magnetic beads into the microwell, for example by adding a demulsifier to the plurality of microwells; and (5) distributing a plurality of cells into the plurality of microwells, such that each or each of substantial portion (e.g., 20%, 30%, 40%, 50%, 60%, 65%, 70%, 75%, 80%, 85%, 90%, 95%, 96%, 97%, 98%, 99%, or more) of the plurality of microwells of the microwell array comprises at most a single cell (e.g., a single cell, or no cell) and at most a single magnetic bead.

In some embodiments, the present disclosure provides a method for distributing particles (e.g., magnetic beads) of various sizes and cells of various sizes into microwells of specific size (e.g., specific diameter) of a microwell array. The method can use microwells of any suitable size. The method can be used to distribute a single particle or a single cell in a microwell, thus avoiding the size limitation for subsequent cell capture. In addition, the method can be used to capture cells of any size, which facilitates further high-throughput preparation (e.g., barcoding) of cell sample.

It can be advantageous that in some embodiments, the size (e.g., diameter) of the droplets can match the size (e.g., diameter) the microwell of the microwell array. The droplets (e.g., water-in-oil droplets with magnetic bead encapsulated therein) can be generated by microfluidic device, and the size of the droplets can be adjusted, by controlling the flow rate or channel design. For example, the droplets (e.g., water-in-oil droplets) can have a size within a predetermined range, which matches the size of the microwells, such that at most a single droplet can be distributed into a microwell.

It can be advantageous that in some embodiments, after the droplets are generated, the method comprises enriching the droplets with particles encapsulated therein. For example, droplets with particles encapsulated therein can be separated from droplets with no particle encapsulated therein, therefore to remove the droplets without particles encapsulated therein from the generated droplets and/or to reduce the number of droplets without particles encapsulated therein in the droplets. In some embodiments, droplets with magnetic bead encapsulated therein can be separated from the droplets without particles encapsulated therein, or be isolated, by magnetic attraction, thereby generating a plurality of droplets wherein the droplets with magnetic bead encapsulated therein are enriched.

It can be advantageous that in some embodiments, the particles (e.g., beads or magnetic beads) comprise a plurality of barcode molecules. In some embodiments, the particle (e.g., a magnetic bead) can be released from the droplet, thereby a single particle is distributed to a microwell of a microwell array. Cells can then be distributed into the microwells with a high rate of a single cell per well without being limited by the size of the cells. Thus, the present method can be used to distribute cells of different sizes into microwells, with each of the microwells comprising at most a single particle (e.g., a magnetic bead) comprising barcode molecules. Accordingly, high-throughput sample preparation for cells of a wide range of sizes can be achieved by the present methods for particle and cell distribution combined with barcoding nucleic acids associated with a cell (e.g., via revere transcription of RNAs associated with the cell).

Provided herein include droplets (e.g., water-in-oil droplets with magnetic bead encapsulated therein) with an adjustable size. The droplets can be enriched by removing droplets with no particle encapsulated therein. The droplets with particle encapsulated therein can then be distributed into microwells of a microwell array. The particle can be released from the droplet (e.g., by demulsifer) thereby each of the microwells can comprise at most a single particle (e.g., a magnetic bead), which allows for high-throughput single cell capture in the microwells. Thus, the present method can adjust the size of the droplets regardless of the sizes of the particle or cells. For particles and cells of given sizes, the present method can be used with microfluidic chips with microwells at different sizes.

### Method of Cell Analysis

Disclosed herein include methods of cell analysis. The method can comprise partitioning a plurality of cells and a plurality of particles into a plurality of partitions, for example wells, microwells, multi-well plates, microwell arrays, microfluidics, dilution, dispensing, droplets, or any other means of sequestering one fraction of a sample from another. In some embodiments, a partition is a well, or a microwell. The plurality of partitions (e.g., wells) can comprise at least 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, or 500,000 partitions. Partitioning the particles or cells into the partitions can comprise loading or introducing the particles or cells, for example, in liquid media into the partitions. In some embodiments, partitioning the particles or cells into the partitions can comprise distributing droplets with the particle encapsulated therein and cells into microwells of a microwell array as disclosed herein.

Analysis of the cell can comprise analyzing a biomolecule associated with the cell. The biomolecules for analysis include, but are not limited to, nucleic acids, proteins (e.g., antibodies or receptors), oligosaccharides, lipids, and a combination thereof. The biomolecule can be inside or attached to the surface of the cell. The biomolecule can be a natural product of the cell or a synthetic molecule associated with the cell. For example, the biomolecule can be an antibody, a ligand, a probe, or a label, attached to the cell. In some embodiments, the biomolecule is a nucleic acid associated with the cell, for example cellular nucleic acid.

In some embodiments, the method of cell analysis comprises providing a plurality of droplets each with a particle encapsulated therein. The method can comprise partitioning the plurality of droplets into a plurality of microwells of a microwell array, thereby, for example, at least 25% of the plurality of microwells can each comprise a single droplet of the plurality of droplets. The method can comprise releasing the particle in each of the single droplet into the microwell comprising the single droplet. The method can comprise partitioning a cell into a microwell of the microwells each with a particle released thereinto. The method can further comprise analyzing a plurality of target nucleic acids associated with the cell using the particle.

In some embodiments, the method of cell analysis comprises partitioning a plurality of cells into microwells of a plurality of microwells of a microwell array. The method can comprise partitioning a plurality of droplets into microwells of the plurality of microwells of the microwell array, each of the droplets comprising a particle encapsulated therein, thereby at least a portion of the plurality of microwells (e.g., at least 25%) each can comprise a single droplet of the plurality of droplets. The method can comprise releasing the particle in each of the single droplets into the microwell comprising the single droplet and the cell. The method can further comprise analyzing a plurality of target nucleic acids associated with the cell using the particle.

The order in which the droplets and cells are partitioned into the microwells can vary in different embodiments. For example, the plurality of cells can be partitioned before the plurality of droplets are partitioned. In some embodiments, the plurality of cells are partitioned after the plurality of droplets are partitioned. In some embodiments, the plurality of cells and the plurality of droplets are partitioned at the same time. In some embodiments, the partitioning of the plurality of cells and the partitioning of the plurality of droplets overlap in time.

In some embodiments, the method of cell analysis comprises co-partitioning (i) a plurality of droplets each with a particle encapsulated therein and (ii) a plurality of cells into a plurality of microwells of a microwell array, thereby, for example, at least 25% of the plurality of microwells of the microwell array can each comprise a single droplet of the plurality of droplets and a single cell of the plurality of cells. The method can comprise releasing the particle in each of the single droplets into the microwell comprising the single droplet. The method can further comprise analyzing a plurality of target nucleic acids associated with a cell using a released particle in a microwell comprising the cell and the released particle.

After partitioning the plurality of droplets into the plurality of microwells of the microwell array, the percentage of microwells of the microwell array each comprising a single droplet, for example, can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, after partitioning the plurality of droplets into the plurality of microwells of the microwell array, at least 25% of the plurality of microwells can each comprise a single droplet of the plurality of droplets. In some embodiments, after partitioning the plurality of droplets, or after co-partitioning (i) the plurality of droplets and (ii) the plurality of cells, at least 50% of the plurality of microwells can each comprise a single droplet of the plurality of droplets. In some embodiments, after releasing the particle in each of the single droplets into the microwell comprising the single droplet, at least 50% of the plurality of microwells each comprises a single particle released thereinto.

After partitioning the plurality of cells into the plurality of microwells of the microwell array, the percentage of microwells of the microwell array each comprising a single cell, for example, can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, after partitioning the plurality of cells, or after co-partitioning (i) the plurality of droplets and (ii) the plurality of cells, at least 50% of the plurality of microwells each comprises a single cell of the plurality of cells.

After partitioning the plurality of droplets and the plurality of cells into the plurality of microwells of the microwell array, the percentage of microwells of the microwell array each comprising a single droplet and a single cell, for example, can be, be about, be at least, be at least about, be at most, or be at most about, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or a number or a range between any two of these values. In some embodiments, after partitioning the plurality of droplets and partitioning the plurality of cells, or after co-partitioning (i) the plurality of droplets and (ii) the plurality of cells, at least 50% of the plurality of microwells can each comprise a single droplet of the plurality of droplets and a single cell of the plurality of cells. In some embodiments, after releasing the particle and after partitioning the plurality of cells, or after co-partitioning (i) the plurality of droplets and (ii) the plurality of cells, at least 50% of the plurality of microwells can each comprise a single particle released thereinto and a single cell of the plurality of cells.

In some embodiments, each of the plurality of microwells can comprise at most one droplet of the plurality of droplets. In some embodiments, each of the plurality of microwells can comprise at most one particle.

### Microwell Array

The microwell array can comprise different numbers of microwells in different implementations. In some embodiments, the microwell array can comprise, comprise about, comprise at least, comprise at least about, comprise at most, or comprise at most about, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values, microwells. The microwells can be arranged into rows and columns, for example. The number of microwells in a row (or a column) can be, be about, be at least, be at least about, be at most, or be at most about, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, or a number or a range between any two of these values. Adjacent rows (or columns) of microwells can be aligned or staggered, for example.

As disclosed herein, a size can be, for example, width, length, depth (or height), radius, diameter, or circumference. The width, length, depth (or height), radius, or diameter of a microwell of the plurality of microwells can be different in different implementations. In some embodiments, the width, length, depth (or height), radius, or diameter of a microwell of the plurality of microwells can be, be about, be at least, be at least about, be at most, or be at most about, 1 μm, 2 μm, 3 μm, 4 μm, 5μ, 6 μm, 7μ, 8μ, 9μ, 10 μm, 20μ, 30μ, 40μ, 50μ, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 600 μm, 700 μm, 800 μm, 900 μm, 1,000 μm, or a number or a range between any two of these values. For example, the width of a microwell of the plurality of microwells can be 10 μm to 500 μm. As another example, the length of a microwell of the plurality of microwells can be 10 μm to 500 μm. As a further example, the depth of a microwell of the plurality of microwells can be 10 μm to 500 μm. In a non-limiting exemplary embodiment, the width of a microwell is 20 μm to 200 μm, the length of a microwell is 20 μm to 200 μm, and the depth of a microwell is 20 μm to 200 μm. The shape of a microwell can be different in different embodiments, for example a microwell can have a circular, elliptical, square, rectangular, triangular, or hexagonal shape.

The volume of one, one or more, or each, of the plurality of microwells can be different in different embodiments. The volume of one, one or more, or each, of the plurality of microwells can be, be about, be at least, be at least about, be at most, or be at most about, 1 nm³, 2 nm³, 3 nm³, 4 nm³, 5 nm³, 6 nm³, 7 nm³, 8 nm³, 9 nm³, 10 nm³, 20 nm³, 30 nm³, 40 nm³, 50 nm³, 60 nm³, 70 nm³, 80 nm³, 90 nm³, 100 nm³, 200 nm³, 300 nm³, 400 nm³, 500 nm³, 600 nm³, 700 nm³, 800 nm³, 900 μm³, 1,000 nm³, 10,000 nm³, 100,000 μm³, 1,000,000 nm³, 10,000,000 nm³, 100,000,000 nm³, 1,000,000,000 nm³, 2 μm³, 3 μm³, 4 μm³, 5 μm³, 6 μm³, 7 μm³, 8 μm³, 9 μm³, 10 μm³, 20 μm³, 30 μm³, 40 μm³, 50 μm³, 60 μm³, 70 μm³, 80 μm³, 90 μm³, 100 μm³, 200 μm³, 300 μm³, 400 μm³, 500 μm³, 600 μm³, 700 μm³, 800 μm³, 900 μm³, 1,000 μm³, 10,000 μm³, 100,000 μm³, 1,000,000 μm³, 10,000,000 μm³, or a number or a range between any two of these values. The volume of one, one or more, or each, of the plurality of microwells can be, be about, be at least, be at least about, be at most, or be at most about, 1 nanolitre (nl), 2 nl, 3 nl, 4 nl, 5 nl, 6 nl, 7 nl, 8 nl, 9 nl, 10 nl, 11 nl, 12 nl, 13 nl, 14 nl, 15 nl, 16 nl, 17 nl, 18 nl, 19 nl, 20 nl, 21 nl, 22 nl, 23 nl, 24 nl, 25 nl, 26 nl, 27 nl, 28 nl, 29 nl, 30 nl, 31 nl, 32 nl, 33 nl, 34 nl, 35 nl, 36 nl, 37 nl, 38 nl, 39 nl, 40 nl, 41 nl, 42 nl, 43 nl, 44 nl, 45 nl, 46 nl, 47 nl, 48 nl, 49 nl, 50 nl, 51 nl, 52 nl, 53 nl, 54 nl, 55 nl, 56 nl, 57 nl, 58 nl, 59 nl, 60 nl, 61 nl, 62 nl, 63 nl, 64 nl, 65 nl, 66 nl, 67 nl, 68 nl, 69 nl, 70 nl, 71 nl, 72 nl, 73 nl, 74 nl, 75 nl, 76 nl, 77 nl, 78 nl, 79 nl, 80 nl, 81 nl, 82 nl, 83 nl, 84 nl, 85 nl, 86 nl, 87 nl, 88 nl, 89 nl, 90 nl, 91 nl, 92 nl, 93 nl, 94 nl, 95 nl, 96 nl, 97 nl, 98 nl, 99 nl, 100 nl, or a number or a range between any two of these values. For example, the volume of one, one or more, or each, of the plurality of microwells can be about 100 μm³ to about 100,000 μm³.

The microwell array comprising a plurality of microwells can be formed from any suitable material. For example, the microwell array can be formed from a material selected from silicon, glass, ceramic, elastomers such as polydimethylsiloxane (PDMS) and thermoset polyester, thermoplastic polymers such as polystyrene, polycarbonate, poly(methyl methacrylate) (PMMA), poly-ethylene glycol diacrylate (PEGDA), Teflon, polyurethane (PU), composite materials such as cyclic-olefin copolymer, and combinations thereof.

The microwells described above can be introduced with samples, free reagents, and/or reagents encapsulated in microcapsules. The reagents can comprise restriction enzymes, ligase, polymerase, fluorophores, oligonucleotide barcodes, oligonucleotide probes, adapters, buffers, dNTPs, ddNTPs, and one or more other reagents required for performing the methods described herein.

### Droplets

The size (e.g., width, length, depth, radius, or diameter) of a droplet can be different in different implementations. For example, the width, length, depth, radius, or diameter of a droplet can be, be about, be at least, be at least about, be at most, or be at most about, 1 μm, 2 μm, 3 μm, 4 μm, 5μ, 6μ, 7μ, 8μ, 9μ, 10μ, 20 μm, 30 μm, 40μ, 50 μm, 60 μm, 70μ, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 600 μm, 700 μm, 800 μm, 900 μm, 1,000 μm, or a number or a range between any two of these values. In some embodiments, a size of the droplet is 5 μm to 200 μm. For example, the width, length, depth, radius, or diameter of a droplet can be 5 μm to 200 μm. The shape of a droplet can also vary, for example, a droplet can have a circular, elliptical, or oval shape.

The volume of one, one or more, or each, of the droplets can be different in different embodiments. The volume of one, one or more, or each, of the plurality of droplets can be, be about, be at least, be at least about, be at most, or be at most about, 1,000 nm³, 10,000 nm³, 100,000 μm³, 1,000,000 nm³, 10,000,000 nm³, 100,000,000 nm³, 1,000,000,000 nm³, 2 μm³, 3 μm³, 4 μm³, 5 μm³, 6 μm³, 7 μm³, 8 μm³, 9 μm³, 10 μm³, 20 μm³, 30 μm³, 40 μm³, 50 μm³, 60 μm³, 70 μm³, 80 μm³, 90 μm³, 100 μm³, 200 μm³, 300 μm³, 400 μm³, 500 μm³, 600 μm³, 700 μm³, 800 μm³, 900 μm³, 1,000 μm³, 10,000 μm³, 100,000 μm³, or a number or a range between any two of these values. The volume of one, one or more, or each, of the plurality of droplets can be, be about, be at least, be at least about, be at most, or be at most about, 1 nanolitre (nl), 2 nl, 3 nl, 4 nl, 5 nl, 6 nl, 7 nl, 8 nl, 9 nl, 10 nl, 11 nl, 12 nl, 13 nl, 14 nl, 15 nl, 16 nl, 17 nl, 18 nl, 19 nl, 20 nl, 21 nl, 22 nl, 23 nl, 24 nl, 25 nl, 26 nl, 27 nl, 28 nl, 29 nl, 30 nl, 31 nl, 32 nl, 33 nl, 34 nl, 35 nl, 36 nl, 37 nl, 38 nl, 39 nl, 40 nl, 41 nl, 42 nl, 43 nl, 44 nl, 45 nl, 46 nl, 47 nl, 48 nl, 49 nl, 50 nl, 51 nl, 52 nl, 53 nl, 54 nl, 55 nl, 56 nl, 57 nl, 58 nl, 59 nl, 60 nl, 61 nl, 62 nl, 63 nl, 64 nl, 65 nl, 66 nl, 67 nl, 68 nl, 69 nl, 70 nl, 71 nl, 72 nl, 73 nl, 74 nl, 75 nl, 76 nl, 77 nl, 78 nl, 79 nl, 80 nl, 81 nl, 82 nl, 83 nl, 84 nl, 85 nl, 86 nl, 87 nl, 88 nl, 89 nl, 90 nl, 91 nl, 92 nl, 93 nl, 94 nl, 95 nl, 96 nl, 97 nl, 98 nl, 99 nl, 100 nl, or a number or a range between any two of these values. For example, the volume of one, one or more, or each, of the plurality of droplets can be about 100 μm³ to about 100,000 μm³.

The size of the droplet can be adjusted based on the size of the microwells in different embodiments. For example, the size of the droplet can be less than the size of the microwell. The size of the droplet and the size of the microwell can be adjusted so that a microwell is capable of fitting at most a single droplet. In some embodiments, a size of the microwell can be, be about, be at least, be at least about, be at most, or be at most about, 1, 1.1, 1.2, 1.3, 1.4, 1.5, 1.6, 1.7, 1.8, 1.9, 2, 2.5, 3, 3.5, 4, 4.5, 5, 6, 7, 8, 9, 10 times a corresponding size of the droplet, or a number or a range between any two of these values. In some embodiments, a size (e.g., width, length, depth, radius, or diameter) of the microwell can be less than 10, 9, 8, 7, 6, 5, 4.5, 4, 3.5, 3, 2.5, 2, 1.5, 1.4, 1.3, 1.2, 1.1 times a corresponding size of the droplet, or a number or a range between any two of these values. In some embodiments, a size of the microwell can be less than 2 times a corresponding size of the droplet. For example, the width of the microwell can be less than 2 times the width of the droplet, the length of the microwell can be less than 2 times the length of the droplet, and/or the depth of the microwell can be less than 2 times the height of the droplet. Matching the size of the droplet to the size of the microwell can avoid distributing multiple droplets into the microwell. In some embodiments, the size of the droplet can be adjusted to fit the size of the microwell, such that each of the plurality of microwells is capable of fitting at most one droplet.

In some embodiments, the methods disclosed herein can comprise generating the plurality of droplets each with a particle encapsulated therein. For example, the method can comprise generating the plurality of droplets each with a particle encapsulated therein and each with a predetermined size. In some embodiments, the method can comprise generating the plurality of droplets each with a particle encapsulated therein and each with a size within a range of a predetermined size.

The droplets can be prepared, for example, by forming an emulsion which comprises the droplets. Emulsions can be heterogenous systems of one liquid dispersed in another in the form of droplets that can be, for example, at least 0.1 μm in diameter. Emulsions can be a biphasic system comprising two immiscible liquid phases intimately mixed and dispersed with each other. For example, an emulsions can be a water-in-oil (w/o) emulsion or an oil-in-water (o/w) emulsion. When an aqueous phase is finely divided into and dispersed as droplets into a bulk oily phase, the resulting composition can be called a water-in-oil (w/o) emulsion. Alternatively, when an oily phase is finely divided into and dispersed as droplets into a bulk aqueous phase, the resulting composition can be called an oil-in-water (o/w) emulsion.

In some embodiments, generating the plurality of droplets each with an encapsulated particle can comprise introducing the particles in a first medium into a second medium to form the plurality of droplets each with an encapsulated particle. The particles can be dispersed in the first medium before the first medium is introduced into the second medium. The first medium and/or the second medium can be introduced as a flowing liquid phase in a channel (such as microchannel). In some embodiments, introducing the particle in the first medium into the second medium can comprise merging the first medium comprising the particles in a first channel with the second medium in a second channel.

In some embodiments, the first medium is an aqueous medium or an aqueous phase and the second medium is a non-aqueous medium. In some embodiments, the first medium is a non-aqueous medium and the second medium is an aqueous medium or an aqueous phase. The non-aqueous medium can be, for example, an oil or an oil phase. The droplets can comprise the first medium as an internal medium (or internal phase) and the second medium as the external medium (or external phase). In some embodiments, the droplet is a water-in-oil droplet. In some embodiments, the droplet is an oil-in-water droplet.

The aqueous medium can be, but is not limited to, water, an aqueous solution, or an aqueous buffer. The aqueous medium can include one or more hydrophilic material, such as glycerol, PEG300, PEG400, polyglycerols, propylene glycols, and derivatives of ethylene glycol. The aqueous buffer can include, but is not limited to, Tris-HCl buffer, EDTA buffer, PBS buffer, HEPES buffer, MOPS buffer, MES buffer, citrate buffer, acetate buffer, phosphate buffer, and combinations thereof. The oil phase can include, but is not limited to, materials such as fatty acid esters, medium chain (C8-C12) mono, di, and tri-glycerides, polyoxyethylated glyceryl fatty acid esters, fatty alcohols, polyglycolized glycerides, saturated polyglycolized C8-C10 glycerides, hydrocarbons (e.g., decane, tetradecane, or hexadecane), animal oils (e.g., oils extracted from fat tissues of pigs, chickens, cows, or fish), vegetable oils (e.g., palm oil, coconut oil, cottonseed oil, canola oil, olive oil, peanut oil, rapeseed oil, soybean oil, or sunflower seed oil), mineral oil, silicone oil, fluorinated oil (e.g., perfluoropolyether oil, perfluoro-compound FC-40 (CAS No. 51142-49-5), 3-ethoxy-1,1,1,2,3,4,4,5,5,6,6,6-dodecafluoro-2-trifluoromethyl-hexane (CAS No. 297730-93-9)), and combinations thereof. In some embodiments, the oil or oil phase can comprise a fluorinated oil.

The first medium and/or the second medium can further comprise an emulsifier or emulsifying agent, which can stabilize the droplets. The emulsifier can include, but is not limited to, lecithin, polyoxyethylene-polyoxypropylene ethers, polyoxyethylene-sorbitan monolaurate, polysorbates, sorbitan esters, stearyl alcohol, tyloxapol, tragacanth, xanthan gum, acacia, agar, alginic acid, sodium alginate, bentonite, carbomer, carboxymethyl cellulose sodium, cholesterol, diacetyl tartaric acid ester of mono- and diglycerides (DATEM), gelatin, hydroxyethyl cellulose, hydroxypropyl cellulose, octoxynol, oleyl alcohol, polyvinyl alcohol, povidone, propylene glycol monostearate, sodium stearoyl lactylate, sodium lauryl sulfate, fluorosurfactant (such as perfluorosulfonic acids (e.g., perfluorooctanesulfonic acid. PFOS), perfluorocarboxylic acids (e.g., perfluorooctanoic acid, or PFOA), or nonionic fluorosurfactants (e.g., 2-propenoic acid, 2-(methyl((nonafluorobutyl) sulfonyl)amino)ethyl ester, CAS No. 1017237-78-3), and combinations thereof. The first medium, the second medium or both can comprise a fluorosurfactant.

Formation of droplets (e.g., by merging the first medium comprising the particles with the second medium) can result in the production of droplets that do not encapsulate any particles. Accordingly, the present method can include an enrichment step to provide droplets in which droplets with particles encapsulated therein are enriched. The particle, for example, can be a magnetic particle, which can be captured, separated and/or isolated, along with the droplet encapsulating the particle, for example by magnetic attraction, thereby enriching the droplets with particles encapsulated therein. In some embodiments, introducing the particles in the first medium into the second medium can comprise introducing the particles in the first medium into the second medium to form a plurality of droplets with no particle encapsulated therein. Further, generating the plurality of droplets each with an encapsulated particle can comprise separating the plurality of droplets each with an encapsulated particle from the plurality of droplets with no particle encapsulated therein.

In some embodiments, the plurality of particles can comprise a plurality of magnetic beads. Separating the plurality of droplets each with an encapsulated particle can comprise separating the plurality of droplets each with an encapsulated particle from the plurality of droplets with no particle encapsulated therein. The separating can comprise capturing the plurality of droplets with encapsulated particles by magnetically attracting the magnetic beads encapsulated in the plurality of droplets.

The size of the droplets can be adjusted, for example, by controlling the flow rates of the first medium comprising the particles in the first channel and the flow rate of the second medium in the second channel. The first medium can have a first flow rate in the first channel. The second medium can have a second flow rate in the second channel. In some embodiments, the predetermined size of the droplet is determined by a flow rate of the first medium relative to a flow rate of the second medium. In some embodiments, introducing the particle in the first medium into the second medium comprises introducing the particles in the first medium at a first flow rate into the second medium at a second flow rate, thereby forming the plurality of droplets each with the predetermined size or each with a size within a range of a predetermined size.

The first flow rate can be, can be about, can be at least about, can be at most, or can be at most about 0.01 μl/min, 0.02 μl/min, 0.03 μl/min, 0.04 μl/min, 0.05 μl/min, 0.06 μl/min, 0.07 μl/min, 0.08 μl/min, 0.09 μl/min, 0.1 μl/min, 0.2 μl/min, 0.3 l/min, 0.4 μl/min, 0.5 μl/min, 0.6 μl/min, 0.7 μl/min, 0.8 μl/min, 0.9 μl/min, 1 μl/min, 2 μl/min, 3 μl/min, 4 μl/min, 5 μl/min, 6 μl/min, 7 μl/min, 8 μl/min, 9 μl/min, 10 μl/min, 20 μl/min, 30 μl/min, 40 μl/min, 50 μl/min, 60 μl/min, 70 μl/min, 80 μl/min, 90 μl/min, 100 μl/min, 1,000 μl/min, 10,000 μl/min, 100,000 μl/min, 1,000,000 μl/min, or a number or a range between any two of these values.

The second flow rate can be, can be about, can be at least about, can be at most, or can be at most about 0.01 μl/min, 0.02 μl/min, 0.03 μl/min, 0.04 μl/min, 0.05 μl/min, 0.06 μl/min, 0.07 μl/min, 0.08 μl/min, 0.09 μl/min, 0.1 μl/min, 0.2 μl/min, 0.3 μl/min, 0.4 μl/min, 0.5 μl/min, 0.6 μl/min, 0.7 μl/min, 0.8 μl/min, 0.9 μl/min, 1 μl/min, 2 μl/min, 3 μl/min, 4 μl/min, 5 μl/min, 6 μl/min, 7 μl/min, 8 μl/min, 9 μl/min, 10 μl/min, 20 μl/min, 30 μl/min, 40 μl/min, 50 μl/min, 60 μl/min, 70 μl/min, 80 μl/min, 90 μl/min, 100 μl/min, 1,000 μl/min, 10,000 μl/min, 100,000 μl/min, 1,000,000 μl/min, 10,000,000 μl/min, or a number or a range between any two of these values.

The ratio of the first flow rate to the second flow rate can be, can be about, can be at least about, can be at most, or can be at most about 0.01:1, 0.02:1, 0.03:1, 0.04:1, 0.05:1, 0.06:1, 0.07:1, 0.08:1, 0.09:1, 0.1:1, 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, 100:1, or a number or a range between any two of these values. In some embodiments, the second flow rate is at least 10 times the first flow rate.

The particle encapsulated in the droplet can be released. Releasing the encapsulated particle can comprise, for example, demulsifying the emulsion comprising the droplets. The demulsification can, for example, separate the emulsion into distinct components, such as the first medium and the second medium. Various demulsifiers can be used to demulsify the emulsion comprising the droplets. In some embodiments, releasing the particle can comprise contacting the single droplet with an encapsulated particle with an demulsifier. The demulsifier can include, but is not limited to, polyalkoxylated alcohol, perfluorooctanoyl, trialkyl phosphates, fluorinated polysiloxanes, polyethylenimine alkoxylates, polyamines, alkoxylated alkylphenol formaldehyde resins, alkoxylated amine-modified alkylphenol formaldehyde resins, polyethylene glycols, polypropylene glycol, ethylene oxide/propylene oxide copolymers, crosslinked ethylene oxide/propylene oxide copolymers, polyols, dendrimers, and combinations thereof.

### Particles

A particle can comprise barcode molecules for analyzing biomolecules (such as nucleic acids) associated with the cell. In some embodiments, the particle can be a bead. The particle (e.g., a bead) can be dissolvable, degradable, or disruptable. A particle can be a gel particle (e.g., a gel bead), such as a hydrogel particle (e.g., a hydrogel bead). In some embodiments, the gel particle is degradable upon application of a stimulus. The stimulus can comprise a thermal stimulus, a chemical stimulus, a biological stimulus, a photo-stimulus, or a combination thereof. The particle can be a solid particle (e.g., a solid bead) and/or a magnetic particle (e.g., a magnetic bead). In some embodiments, the particle is a magnetic particle. The magnetic particle can comprise a paramagnetic material coated or embedded in the magnetic particle (e.g. on a surface, in an intermediate layer, and/or mixed with other materials of the magnetic particle). A paramagnetic material refers to a material having a magnetic susceptibility slightly greater than 1 (e.g. between about 1 and about 5). A magnetic susceptibility is a measure of how much a material can become magnetized in an applied magnetic field. Paramagnetic materials include, but not limited to, magnesium, molybdenum, lithium, aluminum, nickel, tantalum, titanium, iron oxide, gold, copper, or a combination thereof. In some embodiments, the magnetic particle can be immobilized or retained in a microwell by an external magnetic field. The magnetic particle can be mobilized or released when the external magnetic field is removed.

In some embodiments, a particle can be immobilized or retained in a partition (e.g., a microwell or a well) through an interaction between two members of a binding pair. For example, the partition (e.g., microwell or well) can be coated with a capture moiety (e.g., a member of a binding pair) capable of binding with a binding moiety (the other member of the binding pair) comprised in or conjugated to a particle, such that the binding of the two moieties results in the attachment of the particle to the partition (e.g., microwell or well), thereby immobilizing or retaining the particle in the partition. For example, the surface of a partition (e.g., microwell or well) can be coated with streptavidin. The biotinylated particle can be attached to the surface of the partition (e.g., microwell or well) via streptavidin-biotin interaction.

Particles can be of uniform size or heterogeneous size. In some embodiments, a size (e.g., width, length, depth, radius, or diameter) of the particle can be, be about, be at least, be at least about, be at most, or be at most about, 1 μm, 2 μm, 3 μm, 4 μm, 5μ, 6 μm, 7μ, 8 μm, 9μ, 10 μm, 20 μm, 30 μm, 40 μm, 45 μm, 50 μm, 60 μm, 65 μm, 70 μm, 75 μm, 80 μm, 90 μm, 100 μm, 200 μm, 250 μm, 300 μm, 350 μm, 400 μm, 450 μm, 500 μm, 1,000 μm, or a number or a range between any two of these values. In some embodiments, a size of the particle is about 1 μm to about 100 μm. In some embodiments, a size of the particle is about 5 μm to about 100 μm. In some embodiments, the particle can have a size of about 30 μm.

The volume of one, or each, particle can vary. The volume of one, or each, particle can be, be about, be at least, be at least about, be at most, or be at most about, 1,000,000 nm³, 10,000,000 nm³, 100,000,000μ, 1,000,000,000 nm³, 2 μm³, 3 μm³, 4 μm³, 5 μm³, 6 μm³, 7 μm³, 8 μm³, 9 μm³, 10 μm³, 20 μm³, 30 μm³, 40 μm³, 50 μm³, 60 μm³, 70 μm³, 80 μm³, 90 μm³, 100 μm³, 200 μm³, 300 μm³, 400 μm³, 500 μm³, 600 μm³, 700 μm³, 800 μm³, 900 μm³, 1,000 μm³, 10,000 μm³, 100,000 μm³, 1,000,000 μm³, or a number or a range between any two of these values. The volume of one, or each, particle can be, be about, be at least, be at least about, be at most, or be at most about, 1 nanolitre (nL), 2 nL, 3 nL, 4 nL, 5 nL, 6 nL, 7 nL, 8 nL, 9 nL, 10 nL, 11 nL, 12 nL, 13 nL, 14 nL, 15 nL, 16 nL, 17 nL, 18 nL, 19 nL, 20 nL, 21 nL, 22 nL, 23 nL, 24 nL, 25 nL, 26 nL, 27 nL, 28 nL, 29 nL, 30 nL, 31 nL, 32 nL, 33 nL, 34 nL, 35 nL, 36 nL, 37 nL, 38 nL, 39 nL, 40 nL, 41 nL, 42 nL, 43 nL, 44 nL, 45 nL, 46 nL, 47 nL, 48 nL, 49 nL, 50 nL, 51 nL, 52 nL, 53 nL, 54 nL, 55 nL, 56 nL, 57 nL, 58 nL, 59 nL, 60 nL, 61 nL, 62 nL, 63 nL, 64 nL, 65 nL, 66 nL, 67 nL, 68 nL, 69 nL, 70 nL, 71 nL, 72 nL, 73 nL, 74 nL, 75 nL, 76 nL, 77 nL, 78 nL, 79 nL, 80 nL, 81 nL, 82 nL, 83 nL, 84 nL, 85 nL, 86 nL, 87 nL, 88 nL, 89 nL, 90 nL, 91 nL, 92 nL, 93 nL, 94 nL, 95 nL, 96 nL, 97 nL, 98 nL, 99 nL, 100 nL, or a number or a range between any two of these values. In some embodiments, the volume of one, or each, particle is about 100 μm³ to about 100,000 μm³.

The relative size of the droplet to the particle can be adjusted, for example, by controlling the size of the droplet as described herein. In some embodiments, a size of the droplet can be, be about, be at least, be at least about, at most, or be at most about, 1, 1.1, 1.2, 1.3, 1.4, 1.5, 1.6, 1.7, 1.8, 1.9, 2, 2.5, 3, 3.5, 4, 4.5, 5, 6, 7, 8, 9, 10, 20, 30, 40, 50, 60, 70, 80, 90, 100, 200, 300, 400, 500, 600, 700, 800, 900, 1,000, 5,000, 10,000, 100,000, 1,000,000 times a corresponding size of the particle, or a number or a range between any two of these values. For example, a size (e.g., width, length, depth, radius, or diameter) of the droplet can be at least 2, 3, 4, 5, 6, 7, 8, 9, 10, 20, 30, 40, 50, 60, 70, 80, 90, 100, 200, 300, 400, 500, 600, 700, 800, 900, 1,000, 10,000 times a corresponding size of the particle, or a number or a range between any two of these values. In some embodiments, a size (e.g., width, length, depth, radius, or diameter) of the droplet is at least 2 times a corresponding size of the particle.

The encapsulated particle can be released from the droplet into the microwell as disclosed herein. The size of the microwell can be, be about, be at least, be at least about, at most, or be at most about, 1, 1.1, 1.2, 1.3, 1.4, 1.5, 1.6, 1.7, 1.8, 1.9, 2, 2.5, 3, 3.5, 4, 4.5, 5, 6, 7, 8, 9, 10, 20, 30, 40, 50, 60, 70, 80, 90, 100, 200, 300, 400, 500, 600, 700, 800, 900, 1,000, 5,000, 10,000, 100,000, 1,000,000 times a corresponding size of the particle, or a number or a range between any two of these values. For example, a size (e.g., width, length, depth, radius, or diameter) of the microwell can be at least 2, 3, 4, 5, 6, 7, 8, 9, 10, 20, 30, 40, 50, 60, 70, 80, 90, 100, 200, 300, 400, 500, 600, 700, 800, 900, 1,000, 10,000 times a corresponding size of the particle, or a number or a range between any two of these values. The microwell can be capable of fitting at least 2, 3, 4, 5, 6, 7, 8, 9, 10, 20, 30, 40, 50, 60, 70, 80, 90, 100, 200, 300, 400, 500, 600, 700, 800, 900, 1,000, 10,000 the particle, or a number or a range between any two of these values. In some embodiments, a size (e.g., width, length, depth, radius, or diameter) of the microwell is at least 2 times a corresponding size of the particle. In some embodiments, each of plurality of microwells can be capable of fitting at least two particles.

### Cells

The types of cells that can analyzed by the methods described herein can vary. The cells can be obtained from any organism of interest. A cell can be, for example, a mammalian cell, including a human cell such as T cells, B cells, natural killer cells, stem cells, cancer cells.

Cells described herein can be obtained from, derived from, cultured from, or progenies of cells cultured from a cell sample. A cell sample comprising cells can be obtained from any source including a clinical sample and a derivative thereof, a biological sample and a derivative thereof, a forensic sample and a derivative thereof, and a combination thereof. A cell sample can be collected from any bodily fluids including, but not limited to, blood, urine, serum, lymph, saliva, anal, and vaginal secretions, perspiration and semen of any organism. A cell sample can be products of experimental manipulation including purification, cell culturation, cell isolation, cell separation, cell quantification, sample dilution, or any other cell sample processing approaches. A cell sample can be obtained by dissociation of any biopsy tissues of any organism including, but not limited to, skin, bone, hair, brain, liver, heart, kidney, spleen, pancreas, stomach, intestine, bladder, lung, esophagus.

In some embodiments, the cell sample is a clinical sample or a derivative thereof, a biological sample or a derivative thereof, an environmental sample or a derivative thereof, a forensic sample or a derivative thereof, or a combination thereof. In some embodiments, the cell sample is collected from blood, urine, serum, lymph, saliva, anal, and vaginal secretions, perspiration, and/or semen of any organism. In some embodiments, the cell sample is obtained from skin, bone, hair, brain, liver, heart, kidney, spleen, pancreas, stomach, intestine, bladder, lung, and/or esophagus of any organism. In some embodiments, the cells are cultured cells, such as cells from a cultured cell line. In some embodiments, the cells comprise immune cells, fibroblast cells, stem cells, or cancer cells.

The size, shape, and volume of the cell can depend on the function of the cell and can be different in different embodiments. A size (e.g., width, length, depth, radius, or diameter) of a cell can be, be about, be at least, be at least about, be at most, or be at most about, 0.1 μm, 1 μm, 2 μm, 3 μm, 4 μm, 5 μm, 6 μm, 7 μm, 8 μm, 9 μm, 10 μm, 20 μm, 30 μm, 40 μm, 45 μm, 50 μm, 60 μm, 65 μm, 70 μm, 75 μm, 80 μm, 90 μm, 100 μm, 200 μm, 250 μm, 300 μm, 350 μm, 400 μm, 450 μm, 500 μm, 600 μm, 700 μm, 800 μm, 900 μm, 1,000 μm, or a number or a range between any two of these values. In some embodiments, a size of the cell is about 1 μm to about 100 μm. In some embodiments, a size (e.g., a diameter) of the cell is at least 50 μm. The cell can have irregular shape, e.g., an axon,

The volume of the cell can be, be about, be at least, be at least about, be at most, or be at most about, 1 μm³, 2 μm³, 3 μm³, 4 μm³, 5 μm³, 6 μm³, 7 μm³, 8 μm³, 9 μm³, 10 μm³, 20 μm³, 30 μm³, 40 μm³, 50 μm³, 60 μm³, 70 μm³, 80 μm³, 90 μm³, 100 μm³, 200 μm³, 300 μm³, 400 μm³, 500 μm³, 600 μm³, 700 μm³, 800 μm³, 900 μm³, 1,000 μm³, 1,000 μm³, 2,000 μm³, 3,000 μm³, 4,000 μm³, 5,000 μm³, 6,000 μm³, 7,000 μm³, 8,000 μm³, 9,000 μm³, 10,000 μm³, 100,000 μm³, 1,000,000 μm³, 10,000,000 μm³ or a number or a range between any two of these values. In some embodiments, the volume of the cell is about 10 μm³ to about 1,000,000 μm³. In some embodiments, the volume of the cell is at least 2,000 μm³. For example, the cell can be a large cell having a volume of at least 2,000 μm³, such as a cardiomyocyte or a nerve cell.

In some embodiments, a size of the microwell can be, be about, be at least, be at least about, be at most, or be at most about, 1, 1.1, 1.2, 1.3, 1.4, 1.5, 1.6, 1.7, 1.8, 1.9, 2, 2.5, 3, 3.5, 4, 4.5, 5, 6, 7, 8, 9, 10 times a corresponding size of the cell, or a number or a range between any two of these values. In some embodiments, a size (e.g., width, length, depth, radius, or diameter) of the microwell can be less than 10, 9, 8, 7, 6, 5, 4.5, 4, 3.5, 3, 2.5, 2, 1.5, 1.4, 1.3, 1.2, 1.1 times a corresponding size of the cell, or a number or a range between any two of these values. In some embodiments, a size of the microwell can be less than 2 times a corresponding size of the cell. For example, the width of the microwell can be less than 2 times the diameter of the cell, the length of the microwell can be less than 2 times the diameter of the cell, and/or the depth of the microwell can be less than 2 times the diameter of the cell.

In some embodiments, a size of the cell can be bigger than a corresponding size of the particle. For example, the size of the cell can be, be about, be at least, be at least about, at most, or be at most about, 1.1, 1.2, 1.3, 1.4, 1.5, 1.6, 1.7, 1.8, 1.9, 2, 2.5, 3, 3.5, 4, 4.5, 5, 6, 7, 8, 9, 10, 20, 30, 40, 50, 60, 70, 80, 90, 100, 200, 300, 400, 500, 600, 700, 800, 900, 1,000, 5,000, 10,000, 100,000, 1,000,000 times a corresponding size of the particle, or a number or a range between any two of these values. In some embodiments, a size of the cell can be smaller than a corresponding size of the particle. For example, the size of the cell can be, be about, be at least, be at least about, at most, or be at most about, 1%, 5%, 10%, 20%, 30%, 40%, 50%, 60%, 70%, 80%, 90%, 95%, of a corresponding size of the particle, or a number or a range between any two of these values.

### Target Nucleic Acids

As described herein, cells can be associated with target nucleic acids. For example, a cell can comprise one or more target nucleic acids (e.g., mRNA) or can be labeled with one or more target nucleic acids (e.g., directly, or indirectly through a binding moiety, such as an antibody conjugated with the nucleic acid). The target nucleic acids associated with the cell can be from, on the surface of, or binding to the surface of the cell. A target nucleic acid can have a sequence (e.g., an mRNA sequence, excluding the poly(A) tail).

The target nucleic acids associated with the cell can comprise deoxyribonucleic acid (DNA), ribonucleic acid (RNA), and/or any combination or hybrid thereof. The target nucleic acids can be single-stranded or double-stranded, or contain portions of both double-stranded or single-stranded sequences. The target nucleic acids can contain any combination of nucleotides, including uracil, adenine, thymine, cytosine, guanine, inosine, xanthine, hypoxanthine, isocytosine, isoguanine and any nucleotide derivative thereof. As used herein, the term “nucleotide” can include naturally occurring nucleotides and nucleotide analogs, including both synthetic and naturally occurring species. The target nucleic acids can be genomic DNA (gDNA), mitochondrial DNA (mtDNA), messenger RNA (mRNA), ribosomal RNA (rRNA), transfer RNA (tRNA), nuclear RNA (nRNA), small interfering RNA (siRNA), small nuclear RNA (snRNA), small nucleolar RNA (snoRNA), small Cajal body-specific RNA (scaRNA), microRNA (miRNA), double stranded (dsRNA), ribozyme, riboswitch or viral RNA, or any nucleic acids that may be obtained from a sample.

The plurality of target nucleic acids can, for example, comprise DNA, genomic DNA (gDNA), ribonucleic acid (RNA), and/or messenger RNA (mRNA). In some embodiments, the plurality of target nucleic acids comprises mRNA, for example a poly-adenylated mRNA.

### Barcoding

In the methods disclosed herein, barcode molecules (e.g., barcode molecules associated with particles) can be introduced into the partitions (e.g., microwells) for barcoding target nucleic acids. In some embodiments, the particles as disclosed herein can comprise a plurality of barcode molecules. For example, the barcode molecules of the plurality of barcode molecules in a single particle can comprise an identical particle barcode sequence and different molecular label sequences. The particles can provide a surface upon which molecules, such as oligonucleotides, can be synthesized or attached. In some embodiments, the plurality of barcode molecules are attached to, reversibly attached to, covalently attached to, or irreversibly attached to the particle.

The particle can comprise, comprise about, comprise at least, comprise at least about, comprise at most, or comprise at most about, 10, 50, 100, 1,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 50,000,000, 100,000,000, 200,000,000, 300,000,000, 400,000,000, 500,000,000, 600,000,000, 700,000,000, 800,000,000, 900,000,000, 1,000,000,000, or a number or a range between any two of these values, barcode molecules. The attachment of barcode molecules to the particle can be covalent or non-covalent via non-covalent bonds such as ionic bonds, hydrogen bonds, or van der Waals interactions. The attachment can be direct to the surface of a particle or indirect through other oligonucleotide sequences attached to the surface of a particle.

In some embodiments, analyzing the plurality of target nucleic acids associated with the cell can comprises barcoding the plurality of target nucleic acids using the plurality of barcode molecules to generate a plurality of barcoded nucleic acids; and analyzing the plurality of barcoded nucleic acids, or products thereof. In some embodiments, analyzing the plurality of barcoded nucleic acids, or products thereof, comprises determining the sequences of the plurality of barcoded nucleic acids, or products thereof.

In some embodiments, analyzing the plurality of barcoded nucleic acids comprises analyzing the sequences of the barcoded nucleic acids. In some embodiments, analyzing the sequences of the barcoded nucleic acids comprises: determining a profile of the one or more cells from the sequences of the barcoded nucleic acids.

### Barcode Molecules

Barcode molecules (e.g., barcode molecules attached to particles) can be partitioned, for example, in microwells or wells. The term “barcode” as used herein can be a verb or a noun. When used as a noun, the term “barcode” or “barcode molecule” refers to a label that can be attached to a polynucleotide, or any variant thereof, to convey information about the polynucleotide. For example, a barcode can be a polynucleotide sequence attached to fragments of the target nucleic acids associated with a cell in the microwell or well. The barcode can then be sequenced alone or with the fragments of the target nucleic acids associated with the cell. The presence of the same barcode on multiple sequences or different barcodes on different sequences can provide information about the cell origin and/or the molecular origin of the sequences. When used as a verb, the term “barcode” refers to a process of attaching a barcode or a barcode molecule to a target nucleic acid associated with the cell.

Barcode molecules can be generated from a variety of different formats, including pre-designed polynucleotide barcodes, randomly synthesized barcode sequences, microarray-based barcode synthesis, random N-mers, or combinations thereof as will be understood by a person skilled in the art.

In some embodiments, the plurality of barcode molecules comprise, comprise about, comprise at least, comprise at least about, comprise at most, or comprise at most about 1, 5, 10, 50, 100, 1,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 50,000,000, 100,000,000, 200,000,000, 300,000,000, 400,000,000, 500,000,000, 600,000,000, 700,000,000, 800,000,000, 900,000,000, 1,000,000,000, or a number or a range between any two of these values.

A barcode molecule (or a segment of a barcode molecule, such as a particle barcode sequence or a molecular label sequences) can be in any suitable length. For example, a barcode molecule (or a segment of a barcode molecule) can be about 2 to about 500 nucleotides in length, about 2 to about 100 nucleotides in length, about 2 to about 50 nucleotides in length, about 2 to about 40 nucleotides in length, about 4 to about 20 nucleotides in length, or about 6 to 16 nucleotides in length. In some embodiments, the barcode molecule (or a segment of a barcode molecule) can be, be about, be at least, be at least about, be at most, or be at most about 2, 3, 4, 5, 6, 7, 8, 9, 10, 11, 12, 13, 14, 15, 16, 17, 18, 19, 20, 25, 30, 35, 40, 45, 50, 55, 60, 65, 70, 85, 90, 95, 100, 150, 200, 250, 300, 400, or 500 nucleotides in length, or a number or a range between any two of these values.

The barcode molecules used herein can comprise a particle barcode sequence and a molecular label sequences (e.g. a unique molecular identifier (UMI)). A barcode molecule can also comprise additional sequences, such as a target binding sequence or region capable of hybridizing to target nucleic acids (e.g. poly(dT) sequence), other recognition or binding sequences, a template switching oligonucleotide (e.g., GGG, such as rGrGrG), and primer sequences (e.g. sequencing primer sequence, such as Read 1 or a PCR primer sequence) for subsequent processing (e.g. PCR amplification) and/or sequencing.

The configuration of the various sequences comprised in a barcode molecule (e.g. particle barcode sequence, UMI, primer sequence, target binding sequence or region, and/or any additional sequences) can vary depending on, for example, the particular configuration desired and/or the order in which the various components of the sequence are added as will be understood to a person skilled in the art. In some embodiments, a barcode molecule has a configuration of 5′-primer sequence-particle barcode sequence-UMI-target binding sequence-3′. In some embodiments, a barcode molecule has a configuration of 5′-primer sequence-particle barcode sequence-UMI-template switching oligonucleotide-3′.

### Particle Barcode Sequence

In some embodiments, the barcode molecules can comprise a particle barcode sequence. Particle barcode sequences can be used to identify the barcoded nucleic acids originate from the cell (or the same partition). Barcoded nucleic acids that originate from the cell (or the same partition) can have an identical particle barcode sequence. A particle barcode sequence can be referred to as a partition specific barcode, such as a microwell specific barcode, or a sample barcode. The particle barcode sequence of the barcode molecules in a partition can be identical or different.

In some embodiments, the particle barcode sequences can serve to track the target nucleic acids associated with the cell throughout the processing (e.g., location of the cells in a plurality of partitions, such as microwells) when the particle barcode sequence associated with the target nucleic acids is determined during sequencing.

The number (or percentage) of barcode molecules introduced in a partition with particle barcode sequences having an identical sequence can be different in different embodiments. In some embodiments, the number of barcode molecules introduced in a partition with particle barcode sequences having an identical sequence is, is about, is at least, is at least about, is at most, or is at most about, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values. In some embodiments, the percentage of barcode molecules introduced in a partition with particle barcode sequences having an identical sequence is, is about, is at least, is at least about, is at most, or is at most about, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.9%, 100%, or a number or a range between any two of these values. For example, the particle barcode sequences of at least two barcode molecules introduced in a partition comprise an identical sequence. In some embodiments, at least two of the particle barcode sequences of the plurality of barcode molecules in the same partition are identical.

A particle barcode sequence can be unique (or substantially unique) to a partition. The number of unique particle barcode sequences can be different in different embodiments. In some embodiments, the number of unique particle barcode sequences is, is about, is at least, is at least about, is at most, or is at most about, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, or a number or a range between any two of these values. In some embodiments, the percentage of unique particle barcode sequences is, is about, is at least, is at least about, is at most, or is at most about, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.9%, 100%, or a number or a range between any two of these values, of the particle barcode sequences of the barcode molecules introduced in a partition. For example, the particle barcode sequences of barcode molecules introduced in two partitions can comprise different sequences. In some embodiments, the particle barcode sequences of at least one barcode molecules in at least two different partitions are different.

In some embodiments, barcode molecules are introduced to the plurality of partitions such that different sets of a plurality of barcode molecules introduced in different partitions have different particle barcode sequences and a same set of plurality of barcode molecules introduced in a same partition have same particle barcode sequence. For example, target nucleic acids associated with a cell in a partition (e.g., a microwell) can be barcoded with the same particle barcode sequences.

The length of a particle barcode sequence of a barcode molecule (or a particle barcode sequence of each barcode molecule or all particle barcode sequences of the plurality of barcode molecules) can be different in different embodiments. In some embodiments, a particle barcode sequence of a barcode molecule (or each particle barcode sequence of each barcode molecule or all particle barcode sequences of the plurality of barcode molecules) is, is about, is at least, is at least about, is at most, or is at most about, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a number or a range between any two of these values, nucleotides in length.

### Molecular Label Sequence

In some embodiments, a barcode molecular can comprise a molecular label sequence or a molecular label. Molecular label sequences can comprise unique molecule identifiers (UMIs). Molecular label sequences can be used to identify molecular origins of the barcoded nucleic acids. Molecular label sequences (e.g., UMIs) are short sequences used to uniquely tag each molecule in a sample in some embodiments. The molecular label sequences of the barcode molecules partitioned into a partition can be identical or different.

In some embodiments, the molecular label sequences of the plurality of barcode molecules are different. The number (or percentage) of molecular label sequences of barcode molecules introduced in a partition (e.g., a microwell) with different sequences can be different in different embodiments. In some embodiments, the number of molecular label sequences of barcode molecules introduced in a microwell with different sequences is, is about, is at least, is at least about, is at most, or is at most about, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values. In some embodiments, the percentage of molecular label sequences of barcode molecules introduced in a microwell with different sequences is, is about, is at least, is at least about, is at most, or is at most about, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.9%, 100%, or a number or a range between any two of these values. For example, the molecular label sequences of two barcode molecules of the plurality of barcode molecules introduced in a microwell can comprise different sequences.

The number of barcode molecules introduced in a microwell with molecular label sequences having an identical sequence can be different in different embodiments. In some embodiments, the number of barcode molecules introduced in a microwell with molecular label sequences having an identical sequence is, is about, is at least, is at least about, is at most, or is at most about, 1, 2, 3, 4, 5, 6, 7, 8, 9, 10, 20, 30, 40, 50, 60, 70, 80, 90, 100, or a number or a range between any two of these values. For example, the molecular label sequences of two barcode molecules introduced in a microwell can comprise an identical sequence.

The number of unique molecular label sequences can vary. For example, the number of unique molecular label sequences can be, be about, be at least, be at least about, be at most, or be at most about, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values.

In some embodiments, at least two of the molecular label sequences of the plurality of barcode molecules in a microwell comprise different molecular label sequences (e.g., unique molecular identifiers).

The length of a molecular label sequence of a barcode molecule (or a molecular label sequence of each barcode molecule) can be different in different embodiments. In some embodiments, a molecular label sequence of a barcode molecule (or a molecular label sequence of each barcode molecule) is, is about, is at least, is at least about, is at most, or is at most about, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a number or a range between any two of these values, nucleotides in length. In some embodiments, the molecular label sequences can be 2-40 nucleotides in length.

In some embodiments, a barcode molecule can comprise a primer sequence. The primer sequence can be a sequencing primer sequence (or a sequencing primer binding sequence) or a PCR primer sequence (or PCR primer binding sequence). For example, the sequencing primer can be a Read 1 sequence, a Read 2 sequence, or a portion thereof. In some embodiments, the barcode molecule comprise a PCR primer binding sequence, which allows for PCR amplification of a barcoded nucleic acid.

The length of the primer sequence can vary. In some embodiments, the primer sequence is 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a number or a range between any two of these values, nucleotides in length. The number (or percentage) of barcode molecules in a partition (e.g., a microwell) each comprising a primer sequence (or each comprising an identical primer sequence) can be different in different embodiments. In some embodiments, the number of barcode molecules in a partition (e.g., a microwell) each comprising a primer sequence (such as a PCR primer binding sequence) is, is about, is at least, is at least about, is at most, or is at most about, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values. In some embodiments, the percentage of barcode molecules in a partition (e.g., a microwell or a well) each comprising a primer sequence (or each comprising an identical primer sequence) is, is about, is at least, is at least about, is at most, or is at most about, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.9%, 100%, or a number or a range between any two of these values.

In some embodiments, each of the plurality of barcode molecules comprises a primer sequence (e.g., a sequencing primer sequence, including but not limited to, a Read 1 sequence, a Read 2 sequence, or a portion thereof).

In some embodiments, a barcode molecule comprises a target binding sequence or region capable of hybridizing to the target nucleic acids, a particular type of target nucleic acids (e.g. mRNA), and/or specific target nucleic acids (e.g. specific gene of interest). In some embodiments, the target binding sequence comprises a poly(dT) sequence and/or a sequence capable of hybridizing to the plurality of target nucleic acids.

The length of a target binding sequence can vary. For example, the target binding sequence can be, be about, be at least, be at least about, be at most, or be at most about, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a number or a range between any two of these values, nucleotides in length. The target binding sequence can be 12-18 deoxythymidines in length. In some embodiments, the target binding sequence can be 20 nucleotides or longer to enable their annealing in reverse transcription reactions at higher temperatures as will be understood by a person of skill in the art.

In some embodiments, barcode molecules comprising target binding sequences are introduced into the microwells together with other reagents such as the reverse transcription reagents. The number of the barcode molecules introduced into a microwell comprising a target binding sequence can vary. For example, the number of barcode molecules introduced into a microwell comprising a target binding sequence (e.g., poly(dT) sequence) can be, be about, be at least, be at least about, be at most, or be at most about, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, or a number or a range between any two of these values.

In some embodiments, the target binding sequence can be on a 3′ end of a barcode molecule of the plurality of barcode molecules introduced in a microwell. Barcode molecules each comprising a poly(dT) target binding sequence can be used to capture (e.g., hybridize to) 3′ end of polyadenylated mRNA transcripts in a target nucleic acid for a downstream 3′ gene expression library construction.

In some embodiments, the target binding sequence can comprise a poly(dT) sequence which is a single-stranded sequence of deoxythymidine (dT) used for first-strand cDNA synthesis catalyzed by reverse transcriptase. In some embodiments, the target binding sequence comprises a poly(dT) sequence can be introduced into the microwells as extension primers to synthesize the first-strand cDNA using the target nucleic acid (e.g. RNA) as a template.

In some embodiments, the poly(dT) of the barcode molecules introduced into a microwell are identical (e.g., same number of dTs). In some embodiments, the poly(dT) of the barcode molecules introduced into a microwell are different (e.g. different numbers of dTs). The percentage of the barcode molecules of the plurality of barcode molecules introduced into a microwell with an identical poly(dT) sequence can vary. In some embodiments, the percentage of the barcode molecules of the plurality of barcode molecules introduced into a microwell with an identical poly(dT) sequence is, is about, is at least, is at least about, is at most, is at most about, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.9%, 100%, or a number or a range between any two of these values.

In some embodiments, the target binding regions of all barcode molecules of the plurality of barcode molecules comprise poly(dT) capable of hybridizing to poly(A) tails of mRNA molecules (or poly(dA) regions or tails of DNA). In some embodiments, the target binding regions of some barcode molecules of the plurality of barcode molecules comprise gene-specific or target-specific primer sequences. For example, a barcode molecule of the plurality of barcode molecules can also comprise a target binding region capable of hybridizing to a specific target nucleic acid associated with the cell, thereby capturing specific targets or analytes of interest. For example, the target binding region capable of hybridizing to a specific target nucleic acid can be a gene-specific primer sequence. The gene-specific primer sequences can be designed based on known sequences of a target nucleic acid of interest. The gene-specific primer sequences can span a nucleic acid region of interest, or adjacent (upstream or downstream) of a nucleic acid region of interest.

The length of the gene-specific primer sequence can vary. For example, a gene-specific primer sequence can be, be about, be at least, be at least about, be at most, or be at most about, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a number or a range between any two of these values, nucleotides in length. In some embodiments, the gene-specific primer sequence is at least 10 nucleotides in length.

The number of the barcode molecules introduced into a microwell comprising a gene-specific primer sequence can vary. For example, the number of barcode molecules introduced into a microwell comprising a gene-specific primer sequence can be, be about, be at least, be at least about, be at most, or be at most about, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values. In some embodiments, the barcode molecules introduced into a microwell comprises a set of different gene-specific primer sequences each capable of binding to a specific target nucleic acid sequence.

The number of different gene-specific primer sequences of the barcode molecules introduced into a microwell can vary. For example, the number of different gene-specific primer sequences of the barcode molecules introduced into a microwell can be, be about, be at least, be at least about, be at most, or be at most about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 200, 300, 400, 500, 600, 700, 800, 900, 1,000, 2,000, 3,000, 4,000, 5,000, 6,000, 7,000, 8,000, 9,000, 10,000, 20,000, 50,000, 1,000,000, or a number or a range between any two of these values.

The number of target nucleic acids of interest (e.g. genes of interest) that the barcode molecules introduced into a microwell are capable of binding can vary. For example, the number of target nucleic acids of interest (e.g. genes of interest) the barcode molecules introduced into a microwell are capable of binding can be, be about, be at least, be at least about, be at most, or be at most about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 200, 300, 400, 500, 600, 700, 800, 900, 1,000, 2,000, 3,000, 4,000, 5,000, 6,000, 7,000, 8,000, 9,000, 10,000, 20,000, 50,000, 1,000,000, or a number or a range between any two of these values. In some embodiments, one barcode molecule introduced into a microwell can bind to a molecule (or a copy) of a target nucleic acid. Barcode molecules introduced into a microwell can bind to molecules (or copies) of a target nucleic acid or a plurality of target nucleic acids.

In some embodiments, the barcode molecules of the plurality of barcode molecules each comprise a poly(dT) sequence, a gene-specific primer sequence, and/or both. The poly(dT) sequence and the gene-specific primer sequence can be on a same barcode molecule or different barcode molecules of the plurality of barcode molecules introduced into a microwell.

The ratio of the number of barcode molecules introduced into a microwell comprising a poly(dT) sequence and the number of barcode molecules introduced into a partition comprising a gene-specific primer sequence can vary. For example, the ratio can be, be about, be at least, be at least about, be at most, be at most about, 1:100, 1:99, 1:98, 1:97, 1:96, 1:95, 1:94, 1:93, 1:92, 1:91, 1:90, 1:89, 1:88, 1:87, 1:86, 1:85, 1:84, 1:83, 1:82, 1:81, 1:80, 1:79, 1:78, 1:77, 1:76, 1:75, 1:74, 1:73, 1:72, 1:71, 1:70, 1:69, 1:68, 1:67, 1:66, 1:65, 1:64, 1:63, 1:62, 1:61, 1:60, 1:59, 1:58, 1:57, 1:56, 1:55, 1:54, 1:53, 1:52, 1:51, 1:50, 1:49, 1:48, 1:47, 1:46, 1:45, 1:44, 1:43, 1:42, 1:41, 1:40, 1:39, 1:38, 1:37, 1:36, 1:35, 1:34, 1:33, 1:32, 1:31, 1:30, 1:29, 1:28, 1:27, 1:26, 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, 33:1, 34:1, 35:1, 36:1, 37:1, 38:1, 39:1, 40:1, 41:1, 42:1, 43:1, 44:1, 45:1, 46:1, 47:1, 48:1, 49:1, 50:1, 51:1, 52:1, 53:1, 54:1, 55:1, 56:1, 57:1, 58:1, 59:1, 60:1, 61:1, 62:1, 63:1, 64:1, 65:1, 66:1, 67:1, 68:1, 69:1, 70:1, 71:1, 72:1, 73:1, 74:1, 75:1, 76:1, 77:1, 78:1, 79:1, 80:1, 81:1, 82:1, 83:1, 84:1, 85:1, 86:1, 87:1, 88:1, 89:1, 90:1, 91:1, 92:1, 93:1, 94:1, 95:1, 96:1, 97:1, 98:1, 99:1, 100:1, or a number or a range between any two of these values.

In some embodiments, a barcode molecule (or each barcode molecule of the plurality of barcode molecules) comprises a template switching oligonucleotide (TSO). A primer comprising a target binding region, such as a poly(dT) sequence, can hybridize to a target nucleic acid (e.g., an mRNA) and be extended by, for example, reverse transcription to generate an extended primer comprising a reverse complement of the target nucleic acid, or a portion thereof (e.g., cDNA). The extended primer or cDNA can be further extended to include the reverse complement of a TSO oligonucleotide or barcode molecule. The resulting barcoded nucleic acid includes the barcodes of the barcode molecule on the 3′-end.

In some embodiments, a barcode molecule does not comprise a TSO. A barcode molecule comprising a target binding region, such as a poly(dT) sequence, can hybridize to a target nucleic acid (e.g., an mRNA) and be extended by, for example, reverse transcription to generate an extended primer comprising a reverse complement of the target nucleic acid, or a portion thereof (e.g., cDNA). The extended primer or cDNA can be further extended to include the reverse complement of a TSO. The resulting barcoded nucleic acid includes the barcodes of the barcode molecule on the 5′-end. The resulting barcoded nucleic acid (e.g., extended cDNA) can comprise a PCR primer binding sequence introduced in the reverse complement of the TSO.

A TSO is an oligonucleotide that hybridizes to untemplated C nucleotides added by a reverse transcriptase during reverse transcription. The TSO can hybridize to the 3′ end of a cDNA molecule. The TSO can include one or more nucleotides with guanine (G) bases on the 3′-end of the TSO, with which the one or more cytosine (C) bases added by a reverse transcriptase to the 3′-end of a cDNA can hybridize. The series of G bases can comprise 1G base, 2 G bases, 3 G bases, 4 G bases, 5 G bases or more than 5 G bases. The series of G bases can be ribonucleotides. The reverse transcriptase can further extend the cDNA using the TSO as the template to generate a barcoded cDNA comprising the TSO. The length of a TSO can vary. For example, a TSO can be, be about, be at least, be at least about, be at most, or be at most about, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a number or a range between any two of these values, nucleotides in length.

The number of the barcode molecules introduced into a microwell comprising a TSO can vary. In some embodiments, the number of barcode molecules introduced into a microwell comprising a TSO is, is about, is at least, is at least about, is at most, or is at most about, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, 10,000,000, 20,000,000, 30,000,000, 40,000,000, 50,000,000, 60,000,000, 70,000,000, 80,000,000, 90,000,000, 100,000,000, 200,000,000, 300,000,000, 400,000,000, 500,000,000, 600,000,000, 700,000,000, 800,000,000, 900,000,000, 1,000,000,000, or a number or a range between any two of these values.

The TSO of the barcode molecules introduced into a microwell can be identical. In some embodiments, the TSO of the barcode molecules introduced into a microwell is different. The percentage of the barcode molecules of the plurality of barcode molecules introduced into a microwell with an identical TSO sequence can be different in different embodiments. In some embodiments, the percentage of the barcode molecules of the plurality of barcode molecules introduced into a microwell with an identical TSO sequence is, is about, is at least, is at least about, is at most, is at most about, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.9%, 100%, or a number or a range between any two of these values.

### Barcoding Target Nucleic Acids

The method described herein can comprise barcoding target nucleic acids associated with a cell in the partition (e.g., microwell) using the barcode molecules to generate a barcoded nucleic acids (e.g., target nucleic acids each hybridized with a barcode molecule, single-stranded barcoded nucleic acids, or double-stranded barcoded nucleic acids).

The method can, in some embodiments, further comprises releasing the plurality of target nucleic acids associated with the one or more cells in the partition prior to barcoding the plurality of target nucleic acids. In some embodiments, releasing the plurality of target nucleic acids associated with the one or more cells comprises lysing the plurality of cells. For example, prior to analyzing (e.g., barcoding) the target nucleic acids, the method can comprise lysing the cells, thereby releasing the plurality of target nucleic acids from the cell. Lysis agents can be contacted with the cells or cell suspension concurrently. Lysis agents can be introduced to the cells prior to or immediately after subjecting the cells to various pharmaceutical agents in the partitions (e.g., microwells or wells). In some embodiments, the lysis agent does not interfere with effect of the pharmaceutical agent on the cells. Non-limiting examples of lysis agents include bioactive reagents, such as lysis enzymes, or surfactant based lysis solutions including non-ionic surfactants (e.g., Triton X-100 and Tween 20) and ionic surfactants (e.g., sodium dodecyl sulfate (SDS)). Lysis methods including, but not limited to, thermal, acoustic, electrical, or mechanical cellular disruption can also be used.

### First Strand Synthesis and Single-Stranded Barcoded Nucleic Acids

In some embodiments, barcoding the plurality of target nucleic acids comprises a reverse transcription reaction, for example, to generate a plurality of barcoded nucleic acids comprising complementary deoxyribonucleic acids (cDNAs). In some embodiments, barcoding the plurality of target nucleic acids comprises hybridizing the target binding sequence of the barcode molecule to a target nucleic acid of the plurality of target nucleic acids. For example, the target binding sequence can comprise a poly(dT) sequence and/or a sequence capable of hybridizing to the target nucleic acid, such as a sequence comprising a target specific sequence. In some embodiments, the target binding sequence of the barcode molecule comprises a poly(dT) sequence, and barcoding the plurality of target nucleic acids comprises hybridizing the poly(dT) sequence of the target binding sequence to a poly(A) sequence of a target nucleic acid of the plurality of target nucleic acids.

In some embodiments, barcoding the plurality of target nucleic acids comprises extending the plurality of barcode molecules using the plurality of target nucleic acids as templates to generate the plurality of barcoded nucleic acids comprising a plurality of single-stranded barcoded nucleic acids. In some embodiments, the plurality of single-stranded barcoded nucleic acids can be hybridized to the plurality of target nucleic acids in the partition.

In some embodiments, barcoding target nucleic acids associated with a cell in the partition can comprise extending the barcode molecules using the target nucleic acids as templates to generate partially single-stranded/partially double-stranded barcoded nucleic acids hybridized to the target nucleic acids in the partition (or after target nucleic acids hybridized with barcode molecules are pooled). The partially single-stranded/partially double-stranded barcoded nucleic acids hybridized to target nucleic acids can be separated by denaturation (e.g., heat denaturation or chemical denaturation using for example, sodium hydroxide) to generate single-stranded barcoded nucleic acids of the plurality of barcoded nucleic acids. The single-stranded barcoded nucleic acids can comprise a barcode molecule and an oligonucleotide complementary to the target nucleic acids. In some embodiments, the single-stranded barcoded nucleic acids are generated by reverse transcription using a reverse transcriptase. In some embodiments, the single-stranded barcoded nucleic acids is generated by using a DNA polymerase.

In some embodiments, the method further comprises introducing a plurality of TSO into the partition (e.g., microwell). Barcoding the plurality of target nucleic acids can comprise extending the plurality of barcode molecules using the plurality of target nucleic acids and the plurality of template switching oligonucleotides as templates to generate the plurality of barcoded nucleic acids comprising a plurality of single-stranded barcoded nucleic acids.

For example, the single-stranded barcoded nucleic acids can be cDNA produced by extending a barcode molecule using a target RNA associated with the cell as a template. The single-stranded barcoded nucleic acids can be further extended using a TSO. The TSO can be introduced into the partitions together with the reverse transcription reagents. For example, a reverse transcriptase can be used to generate a cDNA by extending a barcode molecule hybridized to an RNA. After extending the barcode molecule to the 5′-end of the RNA, the reverse transcriptase can add one or more nucleotides with cytosine (C) bases (e.g. two or three) to the 3′-end of the cDNA. The TSO can include one or more nucleotides with guanine (G) bases (e.g. two or more) on the 3′-end of the TSO. The nucleotides with G bases can be ribonucleotides. The G bases at the 3′-end of the TSO can hybridize to the cytosine bases at the 3′-end of the cDNA. The reverse transcriptase can further extend the cDNA using the TSO as the template to generate a cDNA with the reverse complement of the TSO sequence on its 3′-end. The barcoded nucleic acid can include the barcode sequences (e.g., particle barcode sequence and molecular label sequence (e.g., UMI)) on the 5′-end and a TSO sequence at its 3′-end.

In some embodiments, barcoding the target nucleic acids comprises extending the barcode molecules using the target nucleic acids as templates and the barcode molecules as TSO to generate single-stranded barcoded nucleic acids that are hybridized to the target nucleic acids. In some embodiments, the present method further comprises introducing a plurality of extension primers to the partition. Barcoding the plurality of target nucleic acids can comprise extending the plurality of extension primers using the plurality of target nucleic acids as templates and the plurality of barcode molecules as template switching oligonucleotides to generate the plurality of barcoded nucleic acids comprising a plurality of single-stranded barcoded nucleic acids.

In some embodiments, the barcode molecules can comprise TSO. For example, the plurality of target nucleic acids can comprises poly-adenylated messenger ribonucleic acid (mRNA), and the extension primers can comprise a poly(dT) sequence. The extension primers can be extended using the target nucleic acids as a template. For example, a reverse transcriptase can be used to generate a cDNA by extending an extension primer hybridized to an RNA. After extending the extension primers to the 5′-end of the RNA, the reverse transcriptase can add one or more C bases (e.g. two or three) to the 3′-end of the cDNA. The TSO or barcode molecule can include one or more G bases (e.g. two or more) on the 3′-end of the TSO. The nucleotides with guanine bases can be ribonucleotides. The G bases at the 3′-end of the TSO or barcode molecule can hybridize to the cytosine bases at the 3′-end of the cDNA. The reverse transcriptase can switch template from the mRNA to the TSO or barcode molecule. The reverse transcriptase can further extend the cDNA using the TSO or barcode molecule as the template to generate a cDNA further comprising the reverse complement of the TSO or barcode molecule. In this case, the barcode sequences (e.g., particle barcode sequence and molecular label sequence (e.g., UMI)) are on the 3′-end of the generated cDNA.

In some embodiments, each of the plurality of single-stranded barcoded nucleic acids is hybridized to one of the plurality of target nucleic acids and one of the plurality of template switching oligonucleotides in the partition.

The single-stranded barcoded nucleic acids can be separated from the template target nucleic acids by digesting the template target nucleic acids (e.g., using RNase), by chemical treatment (e.g., using sodium hydroxide), by hydrolyzing the template target nucleic acids, or via a denaturation or melting process by increasing the temperature, adding organic solvents, or increasing pH. Following the melting process, the target nucleic acids can be removed (e.g. washed away) and the single-stranded barcoded nucleic acids can be retained in the partition (e.g. through attachment to the partitions or through attachments to particles which can be retained in the partitions). In some embodiments, the method further comprises removing the plurality of target nucleic acids and the plurality of template switching oligonucleotides hybridized to the single-stranded barcoded nucleic acids. In some embodiments, removing the plurality of target nucleic acids comprises denaturation, thermal denaturation, digesting, or hydrolyzing the plurality of target nucleic acids.

In some embodiments, each of the plurality of single-stranded barcoded nucleic acid comprises a sequence of a barcode molecule of the plurality of barcode molecules (e.g., an actual sequence of the barcode molecule), a sequence of a target nucleic acid of the plurality of target nucleic acids (e.g. a reverse complement of the target nucleic acid), a sequence of a template switching oligonucleotide of the plurality of template switching oligonucleotides (e.g., a reverse complement of the template switching oligonucleotide), and/or a sequence of an extension primer of the plurality of extension primers (e.g., an actual sequence of the extension primer).

### Second Strand Synthesis, Amplification, and Double-Stranded Barcoded Nucleic Acids

The method can further comprise amplifying the plurality of barcoded nucleic acids to generate a plurality of double-stranded barcoded nucleic acids in the partition (e.g., microwell) using the single-stranded barcoded nucleic acids as templates. The amplifying step can be used to amplify the product of first strand synthesis. In some embodiments, each of the plurality of barcode molecules can comprise a primer sequence. The primer sequence can comprise, for example, a PCR primer sequence. Amplifying the plurality of barcoded nucleic acids can comprise amplifying the plurality of barcoded nucleic acids using the primer sequences in single-stranded barcoded nucleic acids of the plurality of single-stranded barcoded nucleic acids, or products thereof.

For example, barcoding target nucleic acids associated with the cell in the partition (e.g., microwell) can comprise amplifying the barcoded nucleic acids (such as a single-stranded barcoded nucleic acid, or a cDNA generated by using a barcode molecule as disclosed herein). The amplification can comprise generating barcoded nucleic acids comprising double-stranded barcoded nucleic acids in the partition using the single-stranded barcoded nucleic acids as templates. The double-stranded barcoded nucleic acids can be generated from the single-stranded barcoded nucleic acids retained in the partition using, for example, second-strand synthesis or one-cycle PCR. Amplification of the barcoded nucleic acids can include additional cycles of PCR reactions.

The generated double-stranded barcoded nucleic acid can be denaturized or melted to generate two single-stranded barcoded nucleic acids: one single-stranded barcoded nucleic acid retained in the partition (e.g., attached to the particle) and the other single-stranded barcoded nucleic acid released into the solution from the retained single-stranded barcoded nucleic acid that can then be pooled to provide a pooled mixture outside the partitions. Both single-stranded barcoded nucleic acids (e.g. retained in the partitions or pooled outside the partitions) can have a sequence comprising a sequence of a barcode molecule (e.g. particle barcode sequence and molecular label sequence (e.g., UMI)) and a sequence of a target nucleic acid or a reverse complement thereof.

### Pooling

The methods disclosed herein can comprise pooling the plurality of barcoded nucleic acids, or products thereof, in each of the plurality of microwells to generate pooled barcoded nucleic acids. Subjecting the plurality of barcoded nucleic acids, or products thereof, to sequencing can comprise subjecting the pooled barcoded nucleic acids, or products thereof, to sequencing. In some embodiments, pooling the plurality of barcoded nucleic acids, or products thereof, comprises pooling the plurality of double-stranded barcoded nucleic acids in the plurality of microwells to generate the pooled barcoded nucleic acids. For example, the method can comprise pooling the barcoded nucleic acids after barcoding the target nucleic acids and before sequencing the barcoded nucleic acids to obtain pooled barcoded nucleic acids.

In some embodiments, pooling barcoded nucleic acids occurs after generating double-stranded barcoded nucleic acids (e.g., after second strand synthesis) or after generating amplified barcoded nucleic acids. The amplified barcoded nucleic acids can be subject to sequencing library construction prior to sequencing. In some embodiments, synthesis of single-stranded barcoded nucleic acids and double-stranded barcoded nucleic acids occur after the pooling of target nucleic acids hybridized with barcode molecules.

In some embodiments the barcode molecules are attached to particles, only single-stranded barcoded nucleic acids released into bulk (e.g., after amplification of the barcoded nucleic acids) are collected by pooling, and the particles are not pooled (e.g. not removed from the microwells) but retained in the microwells (e.g. by an external magnetic field applied on magnetic beads), thereby allowing one to trace the origin of the pooled barcoded nucleic acids, for example, to its original location in the microwells.

The pooled barcoded nucleic acids can be single-stranded or double-stranded (e.g. generated from the single-stranded pooled barcoded nucleic acids by PCR amplification). The pooled barcoded nucleic acids (e.g. amplified barcoded cDNA) can be purified, and optionally further amplified, prior to sequencing library construction. The pooled barcoded nucleic acids with desired length can be selected.

### Sequencing Library Construction

The barcoded nucleic acids (e.g. pooled barcoded nucleic acids) can be further processed prior to sequencing to generate processed barcoded nucleic acids. For example, the method herein can include amplification of barcoded nucleic acids, fragmentation of amplified barcoded nucleic acids, end repair of fragmented barcoded nucleic acids, A-tailing of fragmented barcoded nucleic acids that have been end-repaired (e.g., to facilitate ligation to adapters), and attaching (e.g. by ligation and/or PCR) with a second sequencing primer sequence (e.g. a Read 2 sequence), sample indexes (e.g. short sequences specific to a given sample library), and/or flow cell binding sequences (e.g. P5 and/or P7). Additional PCR amplification can also be performed. This process can also be referred to as sequencing library construction.

PCR amplification can be carried out to generate sufficient mass for the subsequent library construction processes. In some embodiments, the present method comprises performing a polymerase chain reaction in bulk on the pooled barcoded nucleic acids, or the fragmented barcoded nucleic acids, to generate amplified barcoded nucleic acids. For example, the method can comprise performing a polymerase chain reaction in bulk, subsequent to the pooling, on the pooled barcoded nucleic acids, thereby generating amplified barcoded nucleic acids. In some embodiments, performing the polymerase chain reaction in bulk is subsequent to fragmenting the pooled barcoded nucleic acids. The amplification for library preparation can be a separate process from the amplification of the first strand barcoded nucleic acid generated by, for example, the RT reaction as described herein.

In some embodiments, the method comprises fragmenting the pooled barcoded nucleic acids to generate fragmented barcoded nucleic acids to generate fragmented barcoded nucleic acids prior to subjecting the plurality of barcoded nucleic acids, or products thereof, to sequencing. For example, the method can comprise fragmenting (e.g., via enzymatic fragmentation, mechanical force, chemical treatment, etc.) the pooled barcoded nucleic acids to generate fragmented barcoded nucleic acids. Fragmentation can be carried out by any suitable process such as physical fragmentation, enzymatic fragmentation, or a combination of both. For example, the barcoded nucleic acids can be sheared physically using acoustics, nebulization, centrifugal force, needles, or hydrodynamics. The barcoded nucleic acids can also be fragmented using enzymes, such as restriction enzymes and endonucleases.

Fragmentation yields fragments of a desired size for subsequent sequencing. The desired sizes of the fragmented nucleic acids are determined by the limitations of the next generation sequencing instrumentation and by the specific sequencing application as will be understood by a person skilled in the art. For example, when using Illumina technology, the fragmented nucleic acids can have a length of between about 50 bases to about 1,500 bases. In some embodiments, the fragmented barcoded nucleic acids have about 100 bp to 700 bp in length.

Fragmented barcoded nucleic acids can undergo end-repair and A-tailing (to add one or more adenine bases) to form an A overhang. This A overhang allows adapter containing one or more thymine overhanging bases to base pair with the fragmented barcoded nucleic acids.

Fragmented barcoded nucleic acids can be further processed by adding additional sequences (e.g. adapters) for use in sequencing based on specific sequencing platforms. Adapters can be attached to the fragmented barcoded nucleic acids by ligation using a ligase and/or PCR. For example, fragmented barcoded nucleic acids can be processed by adding a second sequencing primer sequence. The second sequencing primer sequence can comprise a Read 2 sequence. An adapter comprising the second primer sequence can be ligated to the fragmented barcoded nucleic acids after, for example, end-repair and A tailing, using a ligase. The adaptor can include one or more thymine (T) bases that can hybridize to the one or more A bases added by A tailing. An adaptor can be, for example, partially double-stranded or double stranded. In some embodiments, the amplified barcoded nucleic acids comprise a sequencing primer sequence.

The adapter can also include platform-specific sequences for fragment recognition by specific sequencing instrument. In some embodiments, the amplified barcoded nucleic acids comprise a sequence for attaching the amplified barcoded nucleic acids to a flow well. For example, the amplified barcoded nucleic acids can comprise an adapter that comprises a sequence for attaching the fragmented barcoded nucleic acids to a flow well of Illumina platforms, such as a P5 sequence, a P7 sequence, or a portion thereof. Different adapter sequences can be used for different next generation sequencing instrument as will be understood by a person skilled in the art.

The adapter can also contain sample indexes to identify samples and to permit multiplexing. Sample indexes enable multiple samples to be sequenced together (i.e. multiplexed) on the same instrument flow cell as will be understood by a person skilled in the art. Adapters can comprise a single sample index or a dual sample indexes depending on the implementations such as the number of libraries combined and the level of accuracy desired.

In some embodiments, the amplified barcoded nucleic acids generated from sequencing library construction can include a P5 sequence, a sample index, a Read 1 sequence, a particle barcode sequence, a molecular label sequence (e.g., UMI), a poly(dT) sequence, a target biding region, a sequence of a target nucleic acid or a portion thereof, a Read 2 sequence, a sample index, and/or a P7 sequence (e.g., from 5′-end to 3′-end). In some embodiments, the amplified barcoded nucleic acids can include a P5 sequence, a sample index, a Read 1 sequence, a particle barcode sequence, a molecular label sequence (e.g., UMI), a sequence of a template switching oligonucleotide, a sequence of a target nucleic acid or a portion thereof, a Read 2 sequence, a sample index, and/or a P7 sequence (e.g., from 5′-end to 3′-end).

Sequencing the barcoded nucleic acids, or products thereof, can comprise sequencing products of the barcoded nucleic acids. Products of the barcoded nucleic acids can include the processed nucleic acids generated by any step of the sequencing library construction process, such as amplified barcoded nucleic acids, fragmented barcoded nucleic acids, fragmented barcoded nucleic acids comprising additional sequences such as the second sequencing primer sequence and/or adapter sequences described herein.

### Sequencing Barcoded Nucleic Acids

The method disclosed herein can comprise sequencing the barcoded nucleic acids or products thereof to obtain nucleic acid sequences of the barcoded nucleic acids. The barcoded nucleic acids generated by the method disclosed herein can comprise barcoded nucleic acids pooled, from each partition (e.g., microwell), into a pooled mixture outside the partitions. The barcoded nucleic acids retained in a partition and the pooled barcoded nucleic acids in a pooled mixture outside the partitions can be sequenced using a same or different sequencing techniques.

In some embodiments, sequencing the plurality of barcoded nucleic acids or products thereof comprises sequencing the pooled barcoded nucleic acids to obtain nucleic acid sequences of the pooled barcoded nucleic acids. As used herein, a “sequence” can refer to the sequence, a complementary sequence thereof (e.g., a reverse, a compliment, or a reverse complement), the full-length sequence, a subsequence, or a combination thereof. The nucleic acids sequences of the pooled barcoded nucleic acids can each comprise a sequence of a barcode molecule (e.g., the particle barcode sequence and the molecular label sequence (e.g., UMI)) and a sequence of a target nucleic acid associated with the cell or a reverse complement thereof.

Pooled barcoded nucleic acids can be sequenced using any suitable sequencing method identifiable. For example, sequencing the pooled barcoded nucleic acids can be performed using high-throughput sequencing, pyrosequencing, sequencing-by-synthesis, single-molecule sequencing, nanopore sequencing, sequencing-by-ligation, sequencing-by-hybridization, next generation sequencing, massively-parallel sequencing, primer walking, and any other sequencing methods known in the art and suitable for sequencing the barcoded nucleic acids generated using the methods herein described.

### Analysis

Method disclosed herein can comprise determining a profile of the cells, for example from the sequence of the barcode nucleic acids. For example, the obtained nucleic acid sequences of the plurality of barcoded nucleic acids (e.g. nucleic acid sequences of pooled barcoded nucleic acids) can be subjected to any downstream post-sequencing data analysis as will be understood by a person of skill in the art. The sequence data can undergo a quality control process to remove adapter sequences, low-quality reads, uncalled bases, and/or to filter out contaminants. The high-quality data obtained from the quality control can be mapped or aligned to a reference genome or assembled de novo.

Profile analysis, for example gene expression quantification and differential expression analysis, can be carried out to identify genes whose expression differs in different cells. Barcoded nucleic acids from a cell can have an identical particle barcode sequence in the sequencing data and can be identified. Barcoded nucleic acids from different cells can have different particle barcode sequences in the sequencing data and can be identified. Barcoded nucleic acids with an identical particle barcode sequence, an identical target sequence, and different molecular label sequences in the sequencing data can be quantified and used to determine the expression of the target.

In some embodiments, the method can comprise determining a profile (e.g. an expression profile, a transcription profile, an omics profile, or a multi-omics profile) of the one or more cells from the sequences of the barcoded nucleic acids. In some embodiments, the profile comprises a single omics profile, such as a transcriptome profile. In some embodiments, the profile comprises a multi-omics profile, which can include profiles of genome (e.g. a genomics profile), proteome (e.g. a proteomics profile), transcriptome (e.g. a transcriptomics profile), epigenome (e.g. an epigenomics profile), metabolome (e.g. a metabolomics profile), and/or microbiome (e.g. microbiome profile). In some embodiments, the multi-omics profile comprises a genomics profile, a proteomics profile, a transcriptomics profile, an epigenomics profile, a metabolomics profile, a chromatics profile, a protein expression profile, a cytokine secretion profile, or a combination thereof.

In some embodiments, the profile comprises an expression of a target nucleic acid of the plurality of target nucleic acids. For example, the expression of the target nucleic acid can comprise an abundance of the target nucleic acid. The abundance of the target nucleic acid can comprise an abundance of molecules of the target nucleic acid barcoded using the barcode molecules. The abundance of the molecules of the target nucleic acid can comprise a number of occurrences of the molecules of the target nucleic acid. In some embodiments, the number of occurrences of the molecules of the target nucleic acid is, is indicated by, or is determined using, a number of the barcoded nucleic acids comprising a sequence of the target nucleic acid and different molecular label sequences in the sequences of the barcoded nucleic acids.

For example, the profile can include an RNA expression profile and/or a protein expression profile. The expression profile can comprise an RNA expression profile, an mRNA expression profile, and/or a protein expression profile. A profile can also be a profile of one or more target nucleic acids (e.g. gene markers) or a selection of genes associated with the cell.

### EXAMPLES

Some aspects of the embodiments discussed above are disclosed in further detail in the following example, which are not in any way intended to limit the scope of the present disclosure.

### Example 1

### Particle and Cell Distribution

An exemplary workflow of the method of particle distribution disclosed herein is illustrated in FIG. 1: (1) providing a plurality of water-in-oil droplets of a specific size, among which some of the water-in-oil droplets each contains a magnetic bead encapsulated therein; (2) enriching the droplets with encapsulated magnetic bead by removing droplets that do not comprise encapsulated magnetic bead from the plurality of droplets; (3) distributing the droplets that have been enriched with droplets each comprising a magnetic bead encapsulated therein into microwells of a microwell array, such that each microwell of the microwell array comprises at most a single droplet; (4) adding a demulsifier to the microwells, thereby breaking the droplets and releasing the magnetic beads into the microwells; and (5) distributing a plurality of cells into the microwells, such that substantial portion of the microwells of the microwell array each comprises at most a single cell and at most a single magnetic bead (e.g., more than 25%, 50%, 75%, 90%, 95% or more of the microwells of the microwell array each comprises a single cell and a single magnetic bead).

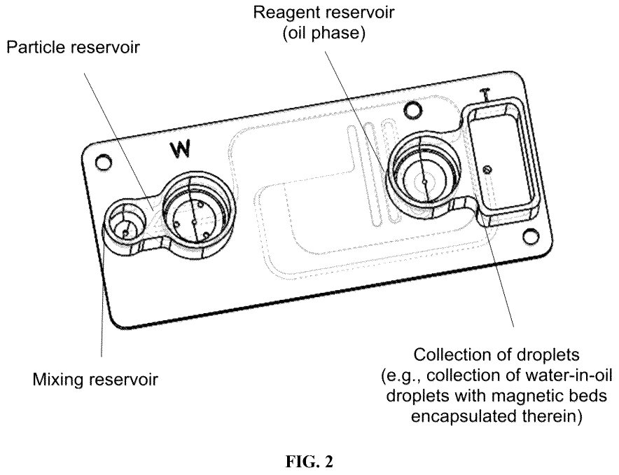

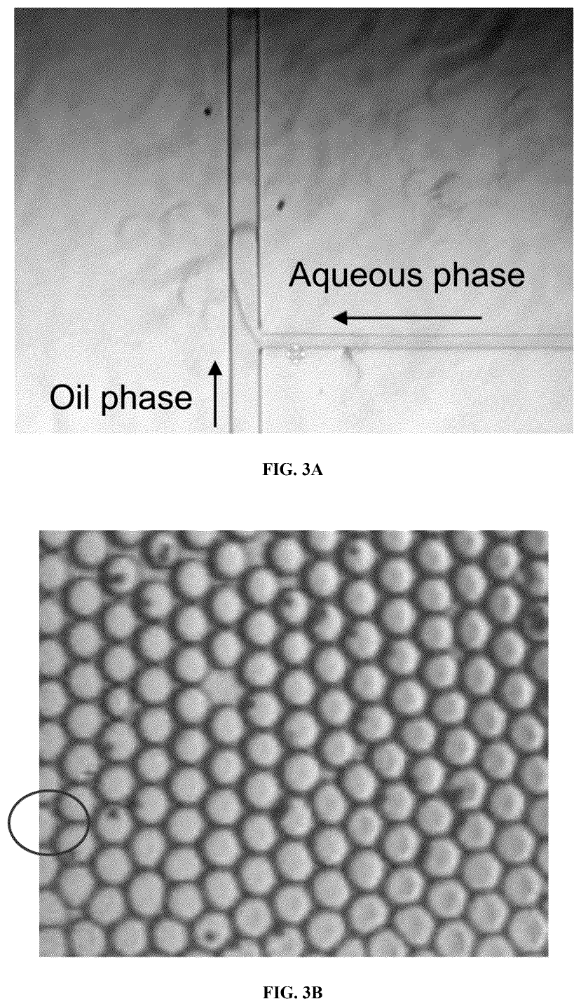

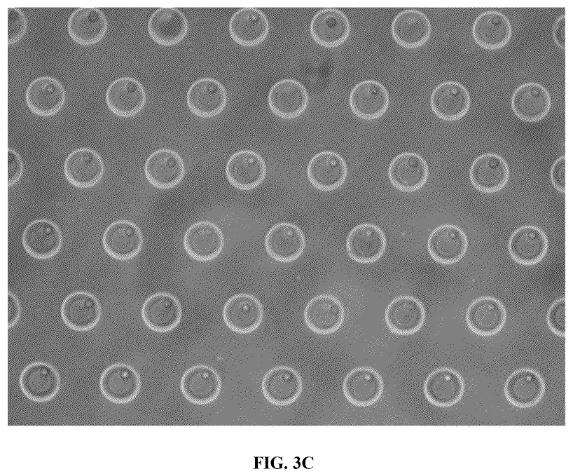

As a non-limiting example, a device for generating droplets with encapsulated particles is shown in FIG. 2. The particles (e.g., magnetic beads) can be mixed with an aqueous medium (e.g., water). Water-in-oil droplets with encapsulated particles can be formed by introducing the particles in the aqueous medium into an oil, and the droplets can be collected. The size of the droplets can be adjusted, for example, by controlling the flow rates of the aqueous phase and the oil phase (FIG. 3A). The microwells can be sized to fit at least two particles (FIGS. 3B and 3C). For example, single particles (e.g., a magnetic beads) having a size of 30 μm can be distributed into microwells having a size of a 100 μm to result in no more than one particle distributed per microwell using the present method (FIG. 3B).

### Terminology

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of particle distribution, comprising:
providing a plurality of droplets each with a particle encapsulated therein;
distributing the plurality of droplets into a plurality of microwells of a microwell array, thereby at least 25% of the plurality of microwells each comprises a single droplet of the plurality of droplets, wherein each of plurality of microwells is capable of fitting at least two particles, and wherein each of the plurality of microwells is capable of fitting at most one droplet; and
releasing the particle in each of the single droplets into the microwell comprising the single droplet, thereby the microwell comprises a single particle.

2. A method of particle and cell distribution, comprising:
distributing a plurality of droplets each with a particle encapsulated therein into a plurality of microwells of a microwell array, thereby at least 25% of the plurality of microwells each comprises a single droplet of the plurality of droplets, wherein each of plurality of microwells is capable of fitting at least two particles, and wherein each of the plurality of microwells is capable of fitting at most one droplet;
releasing the particle in each of the single droplets into the microwell comprising the single droplet, thereby the microwell comprises a single particle; and
distributing a plurality of cells into the plurality of microwells of the microwell array, thereby at least 25% of the plurality of microwells each comprises a single cell of the plurality of cells.

3. A method of particle distribution, comprising:
distributing a plurality of droplets each with a first particle encapsulated therein into a plurality of microwells of a microwell array, thereby at least 25% of the plurality of microwells each comprises a single droplet of the plurality of droplets, wherein each of plurality of microwells is capable of fitting at least two first particles, and wherein each of the plurality of microwells is capable of fitting at most one droplet;
releasing the first particle in each of the single droplets into the microwell comprising the single droplet, thereby the microwell comprises a single first particle; and
distributing a plurality of second particles into the plurality of microwells of the microwell array, thereby at least 25% of the plurality of microwells each comprises a single second particle of the plurality of second particles.

4. The method of any one of claims 1-3, wherein after distributing the plurality of droplets into the plurality of microwells, each of the plurality of microwells comprises at most one droplet.

5. The method of any one of claims 1-4, wherein after releasing the particle in each of the single droplets into the microwell comprising the single droplet, each of the plurality of microwells comprises at most one particle.

6. The method of any one of claims 1-5, wherein after distributing the plurality of droplet into the plurality of microwells, at least 50% of the plurality of microwells each comprises a single droplet of the plurality of droplets.

7. The method of any one of claims 2-6, wherein after distributing the plurality of cells into the plurality of microwells, at least 50% of the plurality of microwells each comprises a single cell of the plurality of cells.

8. The method of any one of claims 2-7, wherein after distributing the plurality of droplets into the plurality of microwells and distributing the plurality of cells into the plurality of microwells, at least 50% of the plurality of microwells each comprises a single droplet of the plurality of droplets and a single cell of the plurality of cells.

9. The method of any one of claims 2-8, wherein distributing the plurality of droplets into the plurality of microwells occurs before distributing the plurality of cells into the plurality of microwells, and/or wherein releasing the particle in each of the single droplets into the microwell comprising the single droplet occurs before distributing the plurality of cells into the plurality of microwells.

10. The method of any one of claims 2-8, wherein distributing the plurality of droplets into the plurality of microwells occurs after distributing the plurality of cells into the plurality of microwells, and/or wherein releasing the particle in each of the single droplets into the microwell comprising the single droplet occurs after distributing the plurality of cells into the plurality of microwells.

11. The method of any one of claims 2-8, wherein distributing the plurality of droplets into the plurality of microwells and distributing the plurality of cells into the plurality of microwells occur simultaneously.

12. The method of any one of claims 1-11, wherein a size of the droplet is at least 2 times a corresponding size of the particle.

13. A method of cell analysis, comprising:
providing a plurality of droplets each with a particle encapsulated therein;
partitioning the plurality of droplets into a plurality of microwells of a microwell array, thereby at least 25% of the plurality of microwells each comprises a single droplet of the plurality of droplets;
releasing the particle in each of the single droplet into the microwell comprising the single droplet;
partitioning a cell into a microwell of the microwells each with a particle released thereinto; and
analyzing a plurality of target nucleic acids associated with the cell using the particle.

14. A method of cell analysis, comprising:
partitioning a plurality of cells into microwells of a plurality of microwells of a microwell array;
partitioning a plurality of droplets into microwells of the plurality of microwells of the microwell array, each of the droplets comprising a particle encapsulated therein, thereby at least a portion of the plurality of microwells each comprises a single droplet of the plurality of droplets;
releasing the particle in each of the single droplets into the microwell comprising the single droplet and the cell; and
analyzing a plurality of target nucleic acids associated with the cell using the particle.

15. The method of claim 14, wherein the plurality of cells are partitioned before the plurality of droplets are partitioned.

16. The method of claim 14, wherein the plurality of cells are partitioned after the plurality of droplets are partitioned.

17. A method of cell analysis, comprising:
co-partitioning (i) a plurality of droplets each with a particle encapsulated therein and (ii) a plurality of cells into a plurality of microwells of a microwell array, thereby at least 25% of the plurality of microwells of the microwell array each comprises a single droplet of the plurality of droplets and a single cell of the plurality of cells;
releasing the particle in each of the single droplets into the microwell comprising the single droplet; and
analyzing a plurality of target nucleic acids associated with a cell using a released particle in a microwell comprising the cell and the released particle.

18. The method of any one of claims 13-17, wherein after partitioning the plurality of droplets, or after co-partitioning (i) the plurality of droplets and (ii) the plurality of cells, at least 50% of the plurality of microwells each comprises a single droplet of the plurality of droplets.

19. The method of any one of claims 13-18, wherein after releasing the particle in each of the single droplets into the microwell comprising the single droplet, at least 50% of the plurality of microwells each comprises a single particle released thereinto.

20. The method of any one of claims 13-20, wherein after partitioning the plurality of cells, or after co-partitioning (i) the plurality of droplets and (ii) the plurality of cells, at least 50% of the plurality of microwells each comprises a single cell of the plurality of cells.

21. The method of any one of claims 13-20, wherein after partitioning the plurality of droplets and partitioning the plurality of cells, or after co-partitioning (i) the plurality of droplets and (ii) the plurality of cells, at least 50% of the plurality of microwells each comprises a single droplet of the plurality of droplets and a single cell of the plurality of cells.

22. The method of any one of claims 13-21, wherein after releasing the particle and after partitioning the plurality of cells, or after co-partitioning (i) the plurality of droplets and (ii) the plurality of cells, at least 50% of the plurality of microwells each comprises a single particle released thereinto and a single cell of the plurality of cells.

23. The method any one of claims 13-22, further comprising, prior to analyzing the plurality of target nucleic acids: lysing the cell, thereby releasing the plurality of target nucleic acids from the cell.

24. The method of any one of claims 13-23, wherein each of the plurality of microwells comprises at most one droplet of the plurality of droplets, and/or wherein each of the plurality of microwells comprises at most one particle.

25. The method of any one of claims 13-24, wherein each of plurality of microwells is capable of fitting at least two particles.

26. The method of any one of claims 13-25, wherein each of the plurality of microwells is capable of fitting at most one droplet.

27. The method of any one of claims 13-26, wherein a size of the droplet is at least 2 times a corresponding size of the particle.

28. The method of any one of claims 13-27, wherein a size of the cell is bigger than a corresponding size of the particle.

29. The method of any one of claims 13-28, wherein a size of the cell is smaller than a corresponding size of the particle.

30. The method of any one of claims 1-29, wherein a size of the droplet is 5 μm to 200 μm, and/or wherein a volume of the droplet is about 100 μm³ to 100,000 μm³.

31. The method of any one of claims 1-30, wherein a volume of a microwell of the plurality of microwells is about 100 μm³ to 100,000 μm³.

32. The method of any one of claims 1-31, wherein a width of a microwell of the plurality of microwells is 10 μm to 500 μm.

33. The method of any one of claims 1-32, wherein a length of a microwell of the plurality of microwells is 10 μm to 500 μm.

34. The method of any one of claims 1-33, wherein a depth of a microwell of the plurality of microwells is 10 μm to 500 μm.

35. The method of any one of claims 1-32, wherein a microwell of the plurality of microwells has a circular, elliptical, square, rectangular, triangular, or hexagonal shape.

36. The method of any one of claims 2-35, wherein a size of the microwell is less than 2 times a corresponding size of the droplet.

37. The method of any one of claims 2-36, wherein the width of the microwell is less than 2 times the width of the droplet.

38. The method of any one of claims 2-37, wherein the length of the microwell is less than 2 times the length of the droplet.

39. The method of any one of claims 32-38, wherein the depth of the microwell is less than 2 times the height of the droplet.

40. The method of any one of claims 1-39, wherein a size of the particle is about 5 μm to about 100 μm, and/or wherein a volume of the particle is about 100 μm³ to 100,000 μm³.

41. The method of any one of claims 2-40, wherein a volume of the cell is at least 2,000 μm³, and/or wherein a diameter of the cell is at least 50 μm.

42. The method of any one of claims 2-41, wherein the width of the microwell is less than 2 times the diameter of the cell.

43. The method of any one of claims 2-42, wherein the length of the microwell is less than 2 times the diameter of the cell.

44. The method of any one of claims 2-43, wherein the depth of the microwell is less than 2 times the diameter of the cell.

45. The method of any one of claims 1-44, comprising generating the plurality of droplets each with a particle encapsulated therein.

46. The method of any one of claims 1-45, comprising generating the plurality of droplets each with a particle encapsulated therein and each with a predetermined size.

47. The method of any one of claims 1-45, comprising generating the plurality of droplets each with a particle encapsulated therein and each with a size within a range of a predetermined size.

48. The method of any one of claim 45, wherein generating the plurality of droplets each with an encapsulated particle comprises: introducing the particles in a first medium into a second medium to form the plurality of droplets each with an encapsulated particle, optionally wherein introducing the particle in the first medium into the second medium comprises: merging the first medium comprising the particles in a first channel with the second medium in a second channel.

49. The method of claim 48, wherein introducing the particles in the first medium into the second medium comprises introducing the particles in the first medium into the second medium to form a plurality of droplets with no particle encapsulated therein, and wherein generating the plurality of droplets each with an encapsulated particle comprises: separating the plurality of droplets each with an encapsulated particle from the plurality of droplets with no particle encapsulated therein.

50. The method of claim 49, wherein the plurality of particles comprise a plurality of magnetic beads, and wherein separating the plurality of droplets each with an encapsulated particle comprises separating the plurality of droplets each with an encapsulated particle from the plurality of droplets with no particle encapsulated therein, which comprises capturing the plurality of droplets with encapsulated particles by magnetically attracting the magnetic beads encapsulated in the plurality of droplets.

51. The method of any one of claims 48-50, wherein the predetermined size of the droplet is determined by a flow rate of the first medium relative to a flow rate of the second medium.

52. The method of any one of claims 48-51, wherein introducing the particle in the first medium into the second medium comprises introducing the particles in the first medium at a first flow rate into the second medium at a second flow rate, thereby forming the plurality of droplets each with the predetermined size or each with a size within a range of a predetermined size.

53. The method of any one of claims 1-52, wherein releasing the particle comprises contacting the single droplet with an encapsulated particle with a demulsifier.

54. The method of any one of claims 1-53, wherein the droplet is a water-in-oil droplet.

55. The method of any one of claims 1-54, wherein the droplet is an oil-in-water droplet.

56. The method of any one of claims 48-55, wherein the first medium is an aqueous medium and the second medium is a non-aqueous medium, optionally wherein the non-aqueous medium is an oil.

57. The method of any one of claims 48-55, wherein the first medium is a non-aqueous medium and the second medium is an aqueous medium, optionally wherein the non-aqueous medium is an oil.

58. The method of any one of claims 1-44, wherein the particle comprises a plurality of barcode molecules, and wherein barcode molecules of the plurality of barcode molecules comprise an identical particle barcode sequence and different molecular label sequences.

59. The method of claim 58, wherein analyzing the plurality of target nucleic acids associated with the cell comprises:
barcoding the plurality of target nucleic acids using the plurality of barcode molecules to generate a plurality of barcoded nucleic acids; and
analyzing the plurality of barcoded nucleic acids, or products thereof.

60. The method of any one of claims 58-59, wherein barcode molecules of the plurality of barcode molecules further comprise a target binding sequence.

61. The method of any one of claims 59-60, wherein barcoding the plurality of target nucleic acids comprises extending the plurality of barcode molecules using the plurality of target nucleic acids as templates to generate the plurality of barcoded nucleic acids comprising a plurality of single-stranded barcoded nucleic acids, optionally hybridized to the plurality of target nucleic acids.

62. The method of claim 61, further comprising introducing a plurality of template switching oligonucleotides into the microwell, wherein barcoding the plurality of target nucleic acids comprises extending the plurality of barcode molecules using the plurality of target nucleic acids and the plurality of template switching oligonucleotides as templates to generate the plurality of barcoded nucleic acids comprising a plurality of single-stranded barcoded nucleic acids.

63. The method of any one of claims 59-60, further comprising introducing a plurality of extension primers to the microwell, and wherein barcoding the plurality of target nucleic acids comprises extending the plurality of extension primers using the plurality of target nucleic acids as templates and the plurality of barcode molecules as template switching oligonucleotides to generate the plurality of barcoded nucleic acids comprising a plurality of single-stranded barcoded nucleic acids.

64. The method of any one of claims 61-63, wherein each of the plurality of single-stranded barcoded nucleic acids is hybridized to one of the plurality of target nucleic acids and one of the plurality of template switching oligonucleotides in the microwell.

65. The method of any one of claims 61-64, further comprising removing the plurality of target nucleic acids and the plurality of template switching oligonucleotides hybridized to the single-stranded barcoded nucleic acids, optionally wherein removing the plurality of target nucleic acids comprises denaturation, thermal denaturation, digesting, or hydrolyzing the plurality of target nucleic acids.

66. The method of any one of claims 61-65, wherein each of the plurality of single-stranded barcoded nucleic acid comprises a sequence of a barcode molecule of the plurality of barcode molecules, a sequence of a target nucleic acid of the plurality of target nucleic acids, a sequence of a template switching oligonucleotide of the plurality of template switching oligonucleotides, and/or a sequence of an extension primer of the plurality of extension primers.

67. The method of claim 65-66, further comprising amplifying the plurality of barcoded nucleic acids to generate a plurality of double-stranded barcoded nucleic acids in the microwell using the single-stranded barcoded nucleic acids as templates.

68. The method of any one of claims 63-67, wherein the plurality of target nucleic acids comprises poly-adenylated messenger ribonucleic acid (mRNA) and the extension primers comprise a poly(dT) sequence.

69. The method of claim 67, wherein each of the plurality of barcode molecules comprises a primer sequence, optionally wherein the primer sequence comprises a PCR primer sequence, wherein amplifying the plurality of barcoded nucleic acids comprises amplifying the plurality of barcoded nucleic acids using the primer sequences in single-stranded barcoded nucleic acids of the plurality of single-stranded barcoded nucleic acids, or products thereof.

70. The method of any one of claims 61-69, wherein the plurality of target nucleic acids comprises deoxyribonucleic acid (DNA).

71. The method of any one of claims 61-69, wherein the plurality of target nucleic acids comprises ribonucleic acid (RNA).

72. The method of claim 71, wherein barcoding the plurality of target nucleic acids comprises a reverse transcription reaction, and wherein the plurality of barcoded nucleic acids comprises complementary deoxyribonucleic acid (cDNA).

73. The method of any one of claims 60-72, wherein barcoding the plurality of target nucleic acids comprises hybridizing the target binding sequence to a target nucleic acid of the plurality of target nucleic acids, and wherein the target binding sequence comprises a poly(dT) sequence and/or a sequence capable of hybridizing to the target nucleic acid, optionally wherein the sequence comprises a target specific sequence.

74. The method of any one of claims 60-73, wherein the target binding sequence of the barcode molecule comprises a poly(dT) sequence, and wherein barcoding the plurality of target nucleic acids comprises hybridizing the poly(dT) sequence of the target binding sequence to a poly(A) sequence of a target nucleic acid of the plurality of target nucleic acids.

75. The method of any one of claims 58-74, wherein the molecular label sequences comprise unique molecule identifiers (UMIs).

76. The method of any one of claims 58-75, wherein the molecular label sequences are 2-40 nucleotides in length.

77. The method of any one of claims 58-76, wherein barcode molecules of the plurality of barcode molecules comprise a primer sequence.

78. The method of claim 77, wherein the primer sequence is a sequencing primer sequence.

79. The method of claim 78, wherein the sequencing primer sequence is a Read 1 sequence, a Read 2 sequence, or a portion thereof.

80. The method of any one of claims 58-79, wherein a barcode molecule of the plurality of barcode molecules comprises a template switching oligonucleotide.

81. The method of claim 58-80, wherein the plurality of barcode molecules are attached to, reversibly attached to, covalently attached to, or irreversibly attached to the particle.

82. The method of any one of claims 1-81, wherein the particle is a bead.

83. The method of claim 82, wherein the bead is a solid bead and/or a magnetic bead.

84. The method of claim 83, comprising retaining the bead in the microwell by an external magnetic field.

85. The method of claim 84, wherein the bead comprises a paramagnetic material.

86. The method of any one of claims 59-85, wherein analyzing the plurality of barcoded nucleic acids, or products thereof, comprises determining the sequences of the plurality of barcoded nucleic acids, or products thereof.
